(19) United States
(12) Patent Application Publication
(10) Pub. No.: US 2024/0296742 A1
(43) Pub. Date: Sep. 5, 2024

(54) PRE-OPERATIONAL INSPECTION FOR A MINING VEHICLE AND A MINING VEHICLE COLLISION AVOIDANCE SYSTEM

(71) Applicant: NEWTRAX TECHNOLOGIES INC., Montreal (CA)

(72) Inventor: Jean-Phillip BOUCHARD, Tampere (CA)

(21) Appl. No.: 18/036,183

(22) PCT Filed: Oct. 20, 2021
(86) PCT No.: PCT/CA2021/051473

§ 371 Date: May 10, 2023

Related U.S. Application Data
(63) Continuation of application No. 63/112,707, filed on Nov. 12, 2020.

(51) Int. Cl. G08G 1/16; H04W 4/40; H04W 4/90

(52) U.S. Cl. CPC G08G 1/161; G08G 1/166; H04W 4/40; H04W 4/90

(57) ABSTRACT

Systems and methods for avoiding collision between a mining vehicle and a personnel identifier system are provided. The personnel identifier system is configured to transmit an identification of the personnel identifier system. The system includes a vehicle system, which has one or more detection subsystems and a controller. Each of the detection subsystems is configured to determine a proximity of the personnel identifier system and receive the identification of the personnel identifier system from the personnel identifier system. The controller is configured to, based on the determination of the proximity of the personnel identifier system relative to the one or more detection subsystems and the identification of the personnel identifier system, diagnose an operating status of each of the one or more detection subsystems.

### CROSS-REFERENCE TO RELATED APPLICATION(S)

None.

### TECHNICAL FIELD

Example embodiments generally relate to systems and methods for avoiding mining vehicle collisions.

### BACKGROUND

Vehicle collision avoidance systems may be used in the mining industry for collision detection and avoidance for both vehicles and personnel. Surface mines and underground mines are challenging environments for operating mining vehicles, said environments having obstacles and personnel that need to be avoided. Collision detection and avoidance systems enable increased safety in the operation of the vehicles and reduces the risk of collisions with obstacles and personnel.

Any operational failures, blocking or other disturbances in the collision avoidance systems may lead to reduced reliability of the operational status of the system, thereby reducing the robustness of the system and presenting a safety risk.

Additional difficulties with existing systems may be appreciated in view of the Detailed Description of Example Embodiments, herein below.

### SUMMARY

Disclosed herein are example embodiments related to a mining vehicle collision avoidance system having a vehicle system with pre-operation inspection capabilities. The collision avoidance system is configured to avoid collisions between a mining vehicle and an operator. The operator is wearing a personnel identifier system that is configured to transmit an identification of the personnel identifier system. The collision avoidance system includes one or more detection subsystems that are mounted to the mining vehicle, and each of the detection subsystems includes a respective wireless communication subsystem that is configured to determine a proximity of the personnel identifier system and receive the identification of the personnel identifier system from the personnel identifier system. The vehicle system includes a memory and a controller for executing instructions stored in the memory that, when executed, causes the controller to, based on the determination of the proximity of the personnel identifier system relative to the one or more detection subsystems and the identification of the personnel identifier system, diagnose an operating status of each of the one or more detection subsystems.

The controller of the vehicle system is configured to determine that the proximity of the personnel identifier system relative to the respective detection subsystem is outside a first threshold proximity, within the first threshold proximity, within a second threshold proximity that is less than the first threshold proximity, and/or within an inspection threshold proximity, and the diagnosing of the operating status of the respective detection subsystem is approved for operation based on the determination that the personnel identifier system is outside the first threshold proximity, within the first threshold proximity of the respective detection subsystem, or within the second threshold proximity.

Each of the one or more detection subsystems comprises a lighting subsystem that includes a variable light output. When the controller of the vehicle system determines that the proximity of the personnel identifier system relative to the respective detection subsystem is outside the first threshold proximity, within the first threshold proximity, or within the second threshold proximity, the controller is configured to variably activate the corresponding light output of the lighting subsystem of the respective detection subsystem to a corresponding output. For example, the controller variably activates the corresponding light output of the lighting subsystem of the respective detection subsystem to illuminate a green colour while the personnel identifier system is outside the first threshold proximity of the respective detection subsystem, a yellow colour while the personnel identifier system is within the first threshold proximity of the respective detection subsystem, and a red colour while the personnel identifier system is within the second threshold proximity of the respective detection subsystem.

Example embodiments relate to a vehicle collision avoidance system for a vehicle system with pre-operation inspection capabilities.

An example embodiment is a mining vehicle collision avoidance system for avoiding collision with a personnel identifier system that is wearable, the personnel identifier system configured to transmit an identification of the personnel identifier system. The system comprises: a vehicle system, comprising: one or more detection subsystems, the one or more detection subsystems including a respective wireless communication subsystem configured to determine a proximity of the personnel identifier system and receive the identification of the personnel identifier system from the personnel identifier system; a memory; and a controller for executing instructions stored in the memory that, when executed, causes the controller to: based on the determination of the proximity of the personnel identifier system relative to the one or more detection subsystems and the identification of the personnel identifier system, diagnose an operating status of each of the one or more detection subsystems.

According to any one of the preceding example embodiments, the determination of the proximity of the personnel identifier system is individually performed on each of the detection subsystems based on the identification of the personnel identifier system.

According to any one of the preceding example embodiments, for each of the one or more detection subsystems, the controller is configured to: determine that the proximity of the personnel identifier system relative to the respective detection subsystem is within a first threshold proximity; and wherein the diagnosing the operating status of the respective detection subsystem is approved for operation based on the determination that the personnel identifier system is within the first threshold proximity of the respective detection subsystem.

According to any one of the preceding example embodiments, for each of the one or more detection subsystems, the controller is configured to: determine that the proximity of the personnel identifier system relative to the respective detection subsystem is within a second threshold proximity, the second threshold proximity being less than the first threshold proximity; and wherein the diagnosing of the respective detection subsystem is approved for operation further based on the determination that the personnel identifier system is within the second threshold proximity of the respective detection subsystem.

According to any one of the preceding example embodiments, each of the one or more detection subsystems further comprises a lighting subsystem that includes a light output, wherein the controller is configured such that: when the diagnosing of the operating status of the respective detection subsystem is approved for operation, activate the light output of the lighting subsystem.

According to any one of the preceding example embodiments, each lighting subsystem comprises a variable light output, the variable light output of the respective lighting subsystem being activatable corresponding to diagnosing of different operating statuses of the respective detection subsystem.

According to any one of the preceding example embodiments, for each of the one or more detection subsystems, the controller is configured such that: when the personnel identifier system is within a first threshold proximity of the respective detection subsystem, variably activate the corresponding light output of the respective lighting subsystem to a first light output.

According to any one of the preceding example embodiments, for each of the one or more detection subsystems, the controller is configured such that: when the personnel identifier system is within a second threshold proximity of the detection subsystem, the second threshold proximity being less than the first threshold proximity, variably activate the corresponding light output of the lighting subsystem to a second light output that is different from the first light output.

According to any one of the preceding example embodiments, for each of the one or more detection subsystems, the controller is configured such that: when the personnel identifier system is outside the first threshold proximity of the respective detection subsystem, variably activate the corresponding light output of the respective lighting subsystem to a different light output that is different from the first light output.

According to any one of the preceding example embodiments, wherein, for each of the one or more detection subsystems, the controller is configured such that: when the personnel identifier system is determined to be outside a first threshold proximity of the respective detection subsystem based on the identification of the personnel identifier system, the diagnosing of the operating status indicates a non-approved operating status.

According to any one of the preceding example embodiments, the controller is configured such that the diagnosing of the operating status of each of the one or more detection subsystems is approved for operation based on a detection sequence amongst the detection subsystems.

According to any one of the preceding example embodiments, the one or more detection subsystems are positioned to detect peripherally about the vehicle system, wherein the detection sequence includes the detection subsystems detecting the proximity of the personnel identifier system in peripherally adjacent sequential order.

According to any one of the preceding example embodiments, the diagnosing of the operating status of each of the one or more detection subsystems is approved for operation based on a detection sequence amongst the detection subsystems; wherein the detection sequence is determined based on the proximity of the personnel identifier system being within: 1) the first proximity of the one or more detection subsystems, and 2) the second proximity of the one or more detection subsystems.

According to any one of the preceding example embodiments, the one or more detection subsystems are positioned to detect peripherally about the vehicle system, wherein the detection sequence includes the detection subsystems detecting the proximity of the personnel identifier system in peripherally adjacent sequential order.

According to any one of the preceding example embodiments, for each of the one or more detection subsystems, the controller is configured to: determine an amount of time that the personnel identifier system is at a predetermined distance from the respective detection subsystem; and wherein the diagnosing the operating status of the respective detection subsystem is approved for operation based on the amount of time exceeding an inspection time threshold.

According to any one of the preceding example embodiments, the controller is configured to determine an amount of time that the personnel identifier system is within the predetermined distance from the respective detection subsystem.

According to any one of the preceding example embodiments, the controller is configured to determine an amount of time that the personnel identifier system is within the predetermined distance at a direction relative to the respective detection subsystem.

According to any one of the preceding example embodiments, the controller is configured to: determine, based on the proximity of the personnel identifier system to the one or more detection systems, a displacement path of the personnel identifier system relative to the vehicle system; and perform the diagnosing based on the displacement path.

According to any one of the preceding example embodiments, the controller is configured to, based on the displacement path of the personnel identifier system relative to the vehicle system, evaluate an inspection time of the vehicle system for the diagnosing.

According to any one of the preceding example embodiments, the controller is configured to: evaluate a visual inspection of a component of a vehicle on which the vehicle system is installed, based on the amount of time that the personnel identifier system is at the predetermined distance from the respective detection subsystem; and wherein the diagnosing the visual inspection of the component of the vehicle is approved based on the amount of time exceeding the inspection time threshold.

According to any one of the preceding example embodiments, the controller is configured to: evaluate a visual inspection of a vehicle on which the vehicle system is installed, based on the displacement path; and wherein the diagnosing the visual inspection of the vehicle is approved based on the displacement path being representative of displacement around the vehicle.

According to any one of the preceding example embodiments, the controller is configured to: determine that the operating status of said system is approved for operation; and enable engine start-up in response to determination that the operating status of said system is approved for operation.

According to any one of the preceding example embodiments, for at least one or more detection subsystems, the controller is configured to determine that no communication can be established between the personnel identifier system and the respective detection subsystem, and in response the diagnosing of the operating status indicates a non-approved operating status of the respective detection subsystem.

According to any one of the preceding example embodiments, the controller is configured to: receive data representative of a successful brake test of the vehicle system; and based on the receiving the data representative of the successful brake test and when the operating status of said system is approved for operation, enable engine start-up.

According to any one of the preceding example embodiments, the controller is configured to initiate the brake test in response to the determination that the operating status of each detection subsystem is approved for operation.

According to any one of the preceding example embodiments, the controller is configured to, prior to receiving the data representative of the successful brake test, bind a brake subsystem of the vehicle system.

According to any one of the preceding example embodiments, the controller is configured to, in response to receiving data representative of the successful brake test, unbind the brake subsystem of the vehicle system.

According to any one of the preceding example embodiments, the controller is configured to: determine an identification of an authorized operator of the vehicle system; and enable, when identification of the personnel identifier system matches the authorized operator and when the diagnosing the operating status of the respective detection subsystem is approved for operation, start-up of the vehicle system.

According to any one of the preceding example embodiments, the controller is configured to: validate, based on data representative of authorization of the user to operate the vehicle system, authority of a user to operate the vehicle system; and in response to successful validation from the validating and the diagnosing of the operating status of the respective detection subsystem being approved for operation, enable start-up of the vehicle system.

According to any one of the preceding example embodiments, the one or more detection subsystems comprises two or more detection subsystems.

According to any one of the preceding example embodiments, the determining of the proximity of the personnel identifier system is performed through each respective wireless communication subsystem using time-of-flight to the personnel identifier system.

According to any one of the preceding example embodiments, the determining of the proximity of the personnel identifier system is performed through triangulation between the personnel identifier system and at least two of the wireless communication subsystems from respective detection subsystems.

According to any one of the preceding example embodiments, the one or more detection subsystems is configured to perform the determining of the proximity of the personnel identifier system and the receiving of the identification of the personnel identifier system from the personnel identifier system using a Bluetooth communication protocol.

According to any one of the preceding example embodiments, the one or more detection subsystems is configured to perform the determining of the proximity of the personnel identifier system and the receiving of the identification of the personnel identifier system from the personnel identifier system using a radio-frequency identification (RFID) communication protocol.

According to any one of the preceding example embodiments, the one or more detection subsystems is configured to perform the determining of the proximity of the personnel identifier system and the receiving of the identification of the personnel identifier system from the personnel identifier system using a wireless communication protocol.

According to any one of the preceding example embodiments, further comprising the personnel identifier system.

According to any one of the preceding example embodiments, the personnel identifier system includes a cap and a lamp mounted to the cap.

Another example embodiment is a mining vehicle, comprising: a collision avoidance system for avoiding collision with a personnel identifier system that is wearable, the personnel identifier system configured to transmit an identification of the personnel identifier system, the system comprising: a vehicle system, comprising: one or more detection subsystems, the one or more detection subsystems including a respective wireless communication subsystem configured to determine a proximity of the personnel identifier system and receive the identification of the personnel identifier system from the personnel identifier system; a memory; and a controller for executing instructions stored in the memory that, when executed, causes the controller to: based on the determination of the proximity of the personnel identifier system relative to the one or more detection subsystems and the identification of the personnel identifier system, diagnose an operating status of each of the one or more detection subsystems.

Another example embodiment is a wearable personnel identifier system configured to be worn by a user, comprising: a cap; a lamp mounted to the cap; a memory for storing information representative of the identity of the user; a wireless communication subsystem; and a controller for executing instructions stored in the memory that, when executed, causes the controller to: wirelessly transmit data representative of the identification of the personnel identifier system; and determine a proximity with a vehicle system.

According to any one of the preceding example embodiments, the vehicle system comprises: one or more detection subsystems, the one or more detection subsystems including a respective wireless communication subsystem configured to determine a proximity of the personnel identifier system and receive the identification of the personnel identifier system from the personnel identifier system; a memory; and a controller for executing instructions stored in the memory that, when executed, causes the controller to: based on the determination of the proximity of the personnel identifier system relative to the one or more detection subsystems and the identification of the personnel identifier system, diagnose an operating status of each of the one or more detection subsystems.

According to any one of the preceding example embodiments, the determination of the proximity of the personnel identifier system is individually performed on each of the detection subsystems based on the identification of the personnel identifier system.

According to any one of the preceding example embodiments, for each of the one or more detection subsystems, the controller is configured to: determine that the proximity of the personnel identifier system relative to the respective detection subsystem is within a first threshold proximity; and wherein the diagnosing the operating status of the respective detection subsystem is approved for operation based on the determination that the personnel identifier system is within the first threshold proximity of the respective detection subsystem.

According to any one of the preceding example embodiments, for each of the one or more detection subsystems, the controller is configured to: determine that the proximity of the personnel identifier system relative to the respective detection subsystem is within a second threshold proximity, the second threshold proximity being less than the first threshold proximity; and wherein the diagnosing of the respective detection subsystem is approved for operation further based on the determination that the personnel identifier system is within the second threshold proximity of the respective detection subsystem.

According to any one of the preceding example embodiments, each of the one or more detection subsystems further comprises a lighting subsystem that includes a light output, wherein the controller is configured such that: when the diagnosing of the operating status of the respective detection subsystem is approved for operation, activate the light output of the lighting subsystem.

According to any one of the preceding example embodiments, each lighting subsystem comprises a variable light output, the variable light output of the respective lighting subsystem being activatable corresponding to the diagnosing of different operating statuses of the respective detection subsystem.

According to any one of the preceding example embodiments, for each of the one or more detection subsystems, the controller is configured such that: when the personnel identifier system is within a first threshold proximity of the respective detection subsystem, variably activate the corresponding light output of the respective lighting subsystem to a first light output.

According to any one of the preceding example embodiments, for each of the one or more detection subsystems, the controller is configured such that: when the personnel identifier system is within a second threshold proximity of the detection subsystem, the second threshold proximity being less than the first threshold proximity, variably activate the corresponding light output of the lighting subsystem to a second light output that is different from the first light output.

According to any one of the preceding example embodiments, for each of the one or more detection subsystems, the controller is configured such that: when the personnel identifier system is outside the first threshold proximity of the respective detection subsystem, variably activate the corresponding light output of the respective lighting subsystem to a different light output that is different from the first light output.

According to any one of the preceding example embodiments, for each of the one or more detection subsystems, the controller is configured such that: when the personnel identifier system is determined to be outside a first threshold proximity of the respective detection subsystem based on the identification of the personnel identifier system, the diagnosing of the operating status indicates a non-approved operating status.

According to any one of the preceding example embodiments, the controller is configured such that the diagnosing of the operating status of each of the one or more detection subsystems is approved for operation based on a detection sequence amongst the detection subsystems.

According to any one of the preceding example embodiments, the one or more detection subsystems are positioned to detect peripherally about the vehicle system, wherein the detection sequence includes the detection subsystems detecting the proximity of the personnel identifier system in peripherally adjacent sequential order.

According to any one of the preceding example embodiments, the diagnosing of the operating status of each of the one or more detection subsystems is approved for operation based on a detection sequence amongst the detection subsystems; and wherein the detection sequence is determined based on the proximity of the personnel identifier system being within: 1) the first proximity of the one or more detection subsystems, and 2) the second proximity of the one or more detection subsystems.

According to any one of the preceding example embodiments, the one or more detection subsystems are positioned to detect peripherally about the vehicle system, wherein the detection sequence includes the detection subsystems detecting the proximity of the personnel identifier system in peripherally adjacent sequential order.

According to any one of the preceding example embodiments, for each of the one or more detection subsystems, the controller is configured to: determine an amount of time that the personnel identifier system is at a predetermined distance from the respective detection subsystem; and wherein the diagnosing the operating status of the respective detection subsystem is approved for operation based on the amount of time exceeding an inspection time threshold.

According to any one of the preceding example embodiments, the controller is configured to determine an amount of time that the personnel identifier system is within the predetermined distance from the respective detection subsystem.

According to any one of the preceding example embodiments, the controller is configured to determine an amount of time that the personnel identifier system is within at a direction relative to the respective detection subsystem.

According to any one of the preceding example embodiments, the controller is configured to: determine, based on the proximity of the personnel identifier system to the one or more detection systems, a displacement path of the personnel identifier system relative to the vehicle system; and perform the diagnosing based on the displacement path.

According to any one of the preceding example embodiments, the controller is configured to, based on the displacement path of the personnel identifier system relative to the vehicle system, evaluate an inspection time of the vehicle system for the diagnosing.

According to any one of the preceding example embodiments, the controller is configured to: evaluate a visual inspection of a component of a vehicle on which the vehicle system is installed, based on the amount of time that the personnel identifier system is at the predetermined distance from the respective detection subsystem; and wherein the diagnosing the visual inspection of the component of the vehicle is approved based on the amount of time exceeding the inspection time threshold.

According to any one of the preceding example embodiments, the controller is configured to: evaluate a visual inspection of a vehicle on which the vehicle system is installed, based on the displacement path; and wherein the diagnosing the visual inspection of the vehicle is approved based on the displacement path being representative of displacement around the vehicle.

Another example embodiment is a method of avoiding collision between a vehicle system and a personnel identifier system that is wearable, the personnel identifier system configured to transmit an identification of the personnel identifier system, the method being executed by a controller of the vehicle system, the vehicle system having one or more detection subsystems, each of the one or more detection subsystems including a respective wireless communication subsystem, configured to determine a proximity of the personnel identifier system and receive the identification of the personnel identifier system from the personnel identifier system, the method comprising: based on the determination of the proximity of the personnel identifier system relative to the one or more detection subsystems and the identification of the personnel identifier system, diagnosing an operating status of each of the one or more detection subsystems.

Another example embodiment is a non-transitory computer-readable medium containing instructions executable by a controller of a vehicle system, the vehicle system having one or more detection subsystems, each of the one or more detection subsystems including a respective wireless communication subsystem, configured to sense determine a proximity of a personnel identifier system and receive an identification of the personnel identifier system from the personnel identifier system, comprising: instructions for, based on the determination of the proximity of the personnel identifier system relative to the one or more detection subsystems and the identification of the personnel identifier system, diagnosing an operating status of each of the one or more detection subsystems.

Other examples aspects will be apparent from the disclosure and drawings provided herein.

### BRIEF DESCRIPTION OF DRAWINGS

For a more complete understanding of the present example embodiments, and the advantages thereof, reference is now made to the following description taken in conjunction with the accompanying drawings, in which:

FIG. 1 is a block diagram of a mining vehicle collision avoidance system, in accordance with an example embodiment;

FIG. 2 is a schematic of the mining vehicle collision avoidance system of FIG. 1;

FIG. 3 is a schematic of the mining vehicle collision avoidance system of FIG. 1;

FIG. 4 is a block diagram of the mining vehicle system;

FIG. 5 is a block diagram of the detection subsystem of the mining vehicle system of FIG. 4;

FIG. 6 is a schematic of a personnel identifier system;

FIG. 7 is a block diagram of the personnel identifier system;

FIG. 8 is a schematic of a personnel identifier system proximate to a mining vehicle system;

FIG. 9 is a flow chart depicting a method of diagnosing the one or more detection subsystems based on the identification of the personnel identifier system and the detection sequence amongst the detection subsystems;

FIG. 10 is a table depicting processing criteria that may be considered for diagnosing the one or more detection subsystems;

FIG. 11 is a schematic of the user interface of FIG. 3;

FIG. 12 is a schematic of a user interface in accordance with an example embodiment.

Similar reference numerals may have been used in different figures to denote similar components.

### DETAILED DESCRIPTION

Disclosed herein is a collision avoidance system that is configured to avoid collision between a mining vehicle and an object in a mine, such as an operator, and further configured to diagnose its operating status. One or more detection subsystems of the collision avoidance system is configured to detect the proximity of the personnel identifier system that is wearable by an operator (e.g. a cap lamp), and is further configured to receive an identification of the personnel identifier system that is transmitted from the personnel identifier system. The system is configured to avoid collision with the personnel identifier system based on the proximity of the personnel identifier system, and is further configured to diagnose an operating status of each of the one or more detection subsystems based on the determination of the proximity of the personnel identifier system relative to the one or more detection subsystems and the identification of the personnel identifier system.

Example embodiments relate to a mining vehicle collision avoidance system for a vehicle system with pre-operation inspection capabilities. For example, the vehicle collision avoidance system is configured to avoid collision with a personnel identifier system that is that is associated with an obstacle or a person. For example, the personnel identifier system may be personal equipment and wearable by a person, for example, as part of their hard hat or cap lamp. The vehicle system includes one or more detection subsystems, each of the one or more detection subsystems including a respective wireless communication subsystem for data communication with the personnel identifier system, for example, through direct communication, peer-to-peer networks, or through communication networks. Each of the one or more detection subsystems is configured to determine a proximity of the personnel identifier system and receive the identification of the personnel identifier system from the personnel identifier system. The vehicle system incudes a vehicle system controller. The vehicle system controller is configured to receive, from the one or more detection subsystems, the data representative of the proximity of the personnel identifier system and the data representative of the identification of the personnel identifier system. Based on the determination of the proximity of the personnel identifier system relative to the one or more detection subsystems and the data representative of the identification of the personnel identifier system, diagnose an operating status of each of the one or more detection subsystems. For example, upon detection that the personnel identifier system has been proximate to each of the one or more detection subsystems, the vehicle system controller may determine that the operating status of the vehicle collision avoidance system is approved for operation.

The vehicle system pre-operation inspection capabilities may include capabilities and elements to inspect that the vehicle collision avoidance system is functioning and approved for operation. The vehicle system pre-operation inspection capabilities may include capabilities and elements to inspect that the vehicle as a whole and its different components and sub-sections are intact and/or functioning and approved for operation. The vehicle system pre-operation inspection capabilities may include capabilities and elements to inspect that the person operating the vehicle is following the inspection process, and/or is authorized to operate the vehicle and/or is equipped with functioning safety systems such as the personnel identifier system. In such a manner, the example embodiments may improve the safety of operating the vehicle by offering a reliable pre-operations inspection capability and process. The example embodiments may also have the advantage that it is possible to identify whether pre-operational inspection has been carried out and identifying the associated operator person.

For example, the system may include a personnel identifier system. The personnel identifier system may be carried or may be wearable by an operator. For example, the personnel identifier system may be included, or partially included, in the personal protective equipment of the operator, such as a cap lamp or hard hat, such that the operator may wear the personnel identifier system while wearing the personal protective equipment. The personnel identifier system includes a personnel identifier system controller that is in operable communication with a personnel identifier system memory. The identifier system controller is configured to transmit data representative of the identification of the personnel identifier system, for example, to the vehicle system controller. The vehicle system controller is configured to receive the data representative of the identification of the personnel identifier system, and based on said data and the proximity of the personnel identifier system relative to one or more detection subsystems, diagnose an operating status of each of the one or more detection subsystems.

The identification of the personnel identifier system may be a bit string or a data structure that is associable with a personnel identifier system. The identifier can be a hardware identifier, e.g. a device identifier, a serial number or another unique code stored in the memory of the device. The identifier may be a network address of the identifier system. In other words, the identification of the personnel identifier system may identify the personnel identification system uniquely such that it is possible to determine the person who is carrying the personnel identifier system, e.g. so that the identifier is associated both with the personnel identifier system and a person's name or employee number or such. This data can be stored, e.g. at a server or another computing system. Such association may happen, e.g., at the time when an operator picks up the personnel identification system (e.g. included or attached to in a cap lamp).

For example, each of the detection subsystems may include a lighting subsystem. Based on the proximity of the personnel identifier system relative to the detection subsystem, the vehicle system controller may variably activate the light output of the lighting subsystem.

For example, upon determination that the vehicle collision avoidance system is approved for operation, the vehicle system controller may be configured to receive data representative of a successful brake test. Such brake test data may be used by the system controller to enable engine start-up and/or operation of the vehicle. Alternatively or in addition, the data may be used to indicate the status of the brakes to the user through a user interface, e.g. a vehicle user interface or the personnel identifier system.

For example, the vehicle system controller may be configured to determine an identification of an authorized operator of the vehicle system, and compare the identification of identifiers of authorized operators of the vehicle system with the identification of the personnel identifier system. When the identification of the personnel identifier system matches an authorized operator identification, the controller may be configured to enable start-up and/or operation of the vehicle. Alternatively or in addition, the system may retrieve information from the server whether the current identification of the personnel identifier is linked to a person's data who is authorized to operate the vehicle, that is, who has task training data linked to the vehicle or the vehicle type on the server. It is to be understood that the term server can refer to a group of servers or a cloud-based arrangement for storing and processing information.

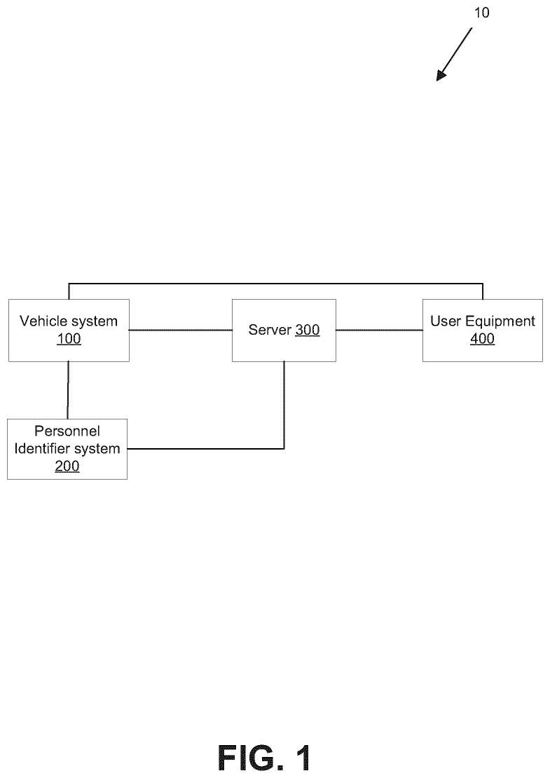

FIG. 1 illustrates a mining vehicle collision avoidance system 10 for avoiding collision with a personnel identifier system, in accordance with an example embodiment. The system 10 may include a vehicle system 100, for example, a mining vehicle system 100, a personnel identifier system 200 for transmitting an identification of the personnel identifier system 200, and a server 300. For example the system 10 may further include a user equipment 400. The vehicle system 100 may be a standalone system installed on a vehicle 50, or it may be partly or fully integrated in a vehicle 50. The personnel identifier system 200 may be a standalone system to be carried by a person, or it may be partly or fully integrated with another device such as a cap lamp device or smart clothing. For example, the server 300 may comprise at least one server, for example, multiple servers or other computing units, such as a server farm, and/or at least one cloud server of a cloud computing solution.

As depicted in FIG. 1, the vehicle system 100 and the personnel identifier system 200 may in direct operable communication, for example, direct wireless communication, and/or may be in operable communication via the server 300.

As depicted in FIG. 1, the vehicle system 100 and the user equipment 400 may in direct operable communication, for example, direct wireless communication, and/or may be in operable communication via the server 300.

For example, the vehicle 50 and the vehicle system 100 may be operated in a mining premises, such as an aboveground mine, underground mine, parking lot, or maintenance area. As described in greater detail herein, the vehicle system 100, in particular, one or more detection subsystems 150 of the vehicle system 100, determines a proximity of a personnel identifier system 200, for example, the presence or absence of the personnel identifier system 200, or the distance between the one or more detection subsystems 150 and the personnel identifier system 200.

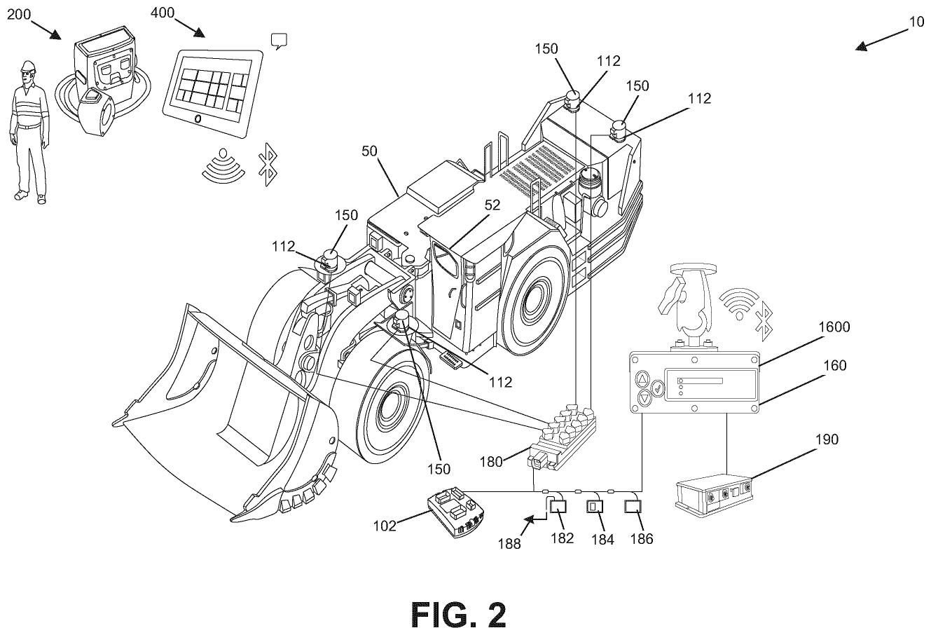

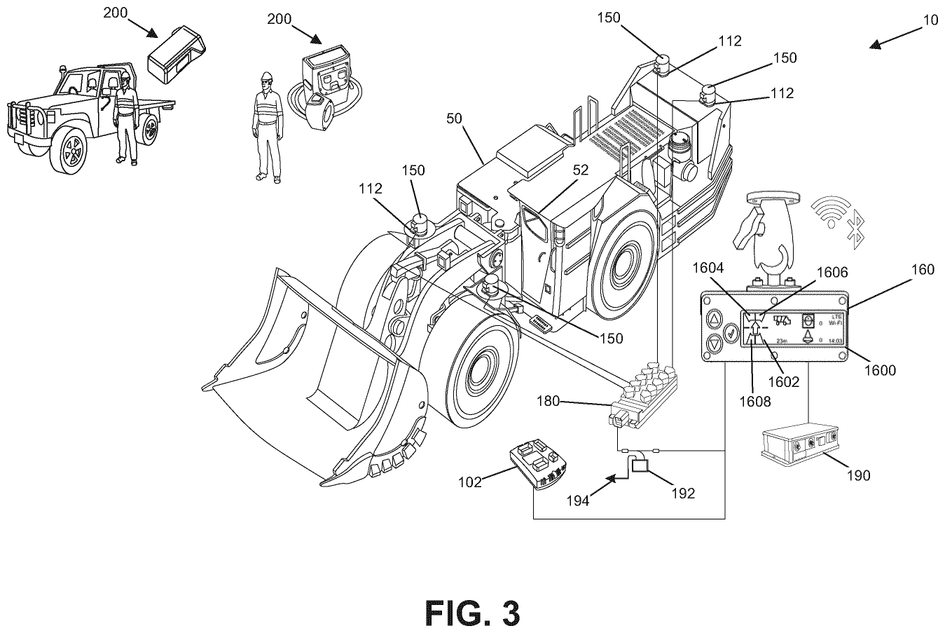

For example, the server 300 may be in a remote location from the premises in which the vehicle system 100 and the vehicle 50 are disposed. For example, the server 300 is a cloud-based server. The server 300 is configured to communicate with the vehicle system 100 and the user equipment 400 according to one or more communication protocols. For example, the server 300 communicates with the vehicle system 100 and the user equipment 400 in a secured manner, for example, via secured or encrypted communications. For example, the server 300 may be arranged to communicate with the vehicle system 100, the personnel identifier system and/or the user equipment 400 over the Internet (e.g. Wi-Fi or the WWAN) for example, or via short message service (SMS) in other examples, or over a mine network such as a leaky feeder communication system or a repeater network, or any combination of such, for notifying the vehicle system 100 to take certain action and/or to receive data from the vehicle system 100 such as inspection data. For example, the server 300 may provide (generate and communicate) a user interface, such as a web-portal, mobile application, or a dashboard for the user equipment 400 to connect to, interact with, or control the vehicle system 100. For example, the server 300 may include a memory for storing data associated with the vehicle system 100, the personnel identifier system 200, and the user equipment 400. The data may include a unique identifier of the vehicle system 100, a unique identifier of the personnel identifier system 200, inspectors of the vehicle system 100, operators of the vehicle system 100, and authorization data of operators to operate the vehicle system 100. Such elements of data may be included in one or more messages or data packets that are transmitted from the personnel identifier system 200, the user equipment 400 and/or the vehicle system 100 to the server 300. For example, the server 300 may communicate with the personnel identifier system 200 via the vehicle system 100. For example, a user may communicate with the personnel identifier system 200 via the user interface 1600 of the vehicle system 100. For example, a user may communicate with the vehicle system 100 via the user interface 1600. As depicted in FIG. 2 and FIG. 3, the user interface 1600 may be incorporated in the same element with the controller 160 (e.g. built into the same enclosure). As another example, user interface 1600 may be separate from the controller 160.

For example, the system 10 may include one or more user equipment 400. The user equipment 400 may be a computer, a laptop, smart phone, cell phone, a tablet, and the like. For example, the server 300 stores software updates to the vehicle system 100 and the personnel identifier system 200, and notifies the user equipment 400, for example, by using a flag to indicate that a software update is available. The user equipment 400 is configured to check the status of the software or the flag for software update in the server 300. For example, the user equipment 400 may push the software from the server 300 to the vehicle system 100 or to the personnel identifier system 200 via a suitable communication modality over the Internet. For example, the server 300 may notify the user equipment 400 of one or more components of the vehicle system 100 and/or the vehicle 50 to be inspected, for example, by a dedicated application, a web portal, emails, or short messages. For example, the user equipment 400, based on inputs from a user, may notify the server 300 of the status of one or more components of the vehicle system 100 to be inspected. The user equipment 400 may, for example, display a checklist to the user and provide input means like an active user interface element to input the status to the user equipment 400. The user equipment 400 or another computing element in the system may then code such information to a message or one or more data packets to be transmitted to the server 300.

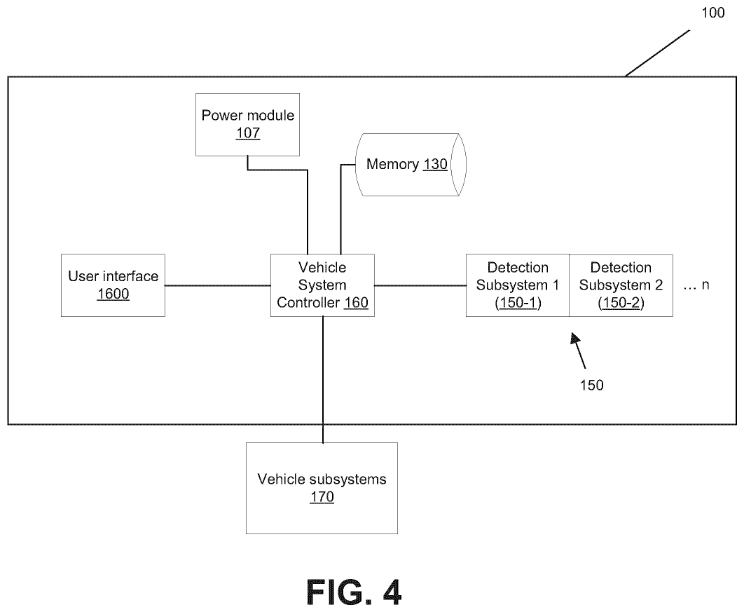

As depicted in FIG. 1, the mining vehicle collision avoidance system 10 includes the vehicle system 100. The vehicle system 100 may be operated in a suitable mining site, may receive the identification of a personnel identifier system from the personnel identifier system, and may detect the proximity, such as the presence or absence of the personnel identifier system, or the distance relative to the personnel identifier system, and may diagnose the operating status of each one of the one or more detection subsystems 150. As depicted in FIG. 4, a vehicle system controller 160 of the vehicle system 100 may be in operable communication with one or more detection subsystems 150-1, 150-2, . . . , 150-n (each and collectively, the detection subsystem 150), a memory 130, and a user interface 1600. For example, the vehicle system controller 160 may be in operable communication with vehicle subsystems 170 of the vehicle 50. The operable communication may be arranged by a wired connection, e.g. through an isolation router, or by a wireless connection. For example, the vehicle system controller 160 may be configured to send commands to the one or more detection subsystems 150, the memory 130, the user interface 1600, and the vehicle subsystems 170, and receive data from the one or more detection subsystems 150, the memory 130, the user interface 1600, and the vehicle subsystems 170. For example, the vehicle system controller 160 may be for controlling operation of the detection subsystem 150, the user interface 1600, and the vehicle subsystems 170. For example, the vehicle collision avoidance system 10 may include a personnel identifier system 200. For example, the vehicle system 100 may be configured to be in operable communication with the personnel identifier system 200, via the vehicle system controller 160, the one or more detection subsystems 150, an personnel identifier system controller 202, and a communication subsystem 203 of the personnel identifier system 200, for example, by sending data or commands to the personnel identifier system 200, or by receiving data or commands from the personnel identifier system 200. For example, the one or more detection subsystems 150 of the vehicle system 100 includes a communication subsystem 103 that is configured to detect or sense the proximity the personnel identifier system 200, the distance between the personnel identifier system 200 and the one or more detection subsystems 150, the amount of time that the personnel identifier system 200 is proximate the one or more detection subsystems 150, the position of the personnel identifier system 200 relative to the one or more detection subsystems 150, and the displacement of the personnel identifier system 200 relative to the one or more detection subsystems 150. The vehicle system 100 may determine the position of the personnel identifier system 200 with respect to the vehicle 50, e.g. by using information from the one or more detection subsystems 150-1, 150-2, . . . , 150-n. For example, the vehicle system 100 may compute the direction relative to the vehicle 50 or one of the detection subsystems 150, a distance from the vehicle 50 or one of the detection subsystems 150, and/or coordinates of the personnel identifier system 200.

For example, the vehicle system 100 may be configured to communicate with the server 300, for example, by uploading the detected data of the identification of the personnel identifier system 200 and the proximity of the personnel identifier system 200, as detected and sensed by the detection subsystem 150, to the server 300. The vehicle system controller 160, via the detection subsystem 150 of the vehicle system 100 and the personnel identifier system controller 202, may be configured to detect the proximity of the personnel identifier system 200 and the identification of the personnel identifier system 200, and may send the associated data to the server 300. The vehicle system controller 160 may also be configured to store the data on the vehicle system 100, such as in the memory 130, or another storage media. Alternatively or in addition, the personnel identifier system 200 may determine the data, receive the data from the vehicle system and/or transmit the data to the server 300. The personnel identifier system controller 202 may also be configured to store the data on the personnel identifier system 200 or another storage media. The server 300 may be configured to store the uploaded data and notify a personnel identifier system 200 and/or a user equipment 400, for example, through an application, a web portal, by emails, or push notification, and the like. For example, data transmitted from the server 300 to the personnel identifier system 200 and/or the user equipment 400 may be real-time ongoing data, for example, data representative of the personnel identifier system 200 that is proximate to the vehicle system 100, and the operating status of the detection subsystems 150 disposed on the vehicle system 100, and their positions on the vehicle system 100. For example, data transmitted from the server 300 to the personnel identifier system 200 and/or user equipment 400 may be specific notifications in response to determination by the vehicle system controller 160 or the server 300 that a particular event occurred, based on the data representative of the identification of the personnel identifier system 200 and the proximity of the personnel identifier system 200. Example events may include the proximity of the personnel identifier system 200 relative to the detection subsystem 150 represented by a colour on the user equipment 400 based on the proximity of the personnel identifier system 200 relative to the detection subsystem 150 (e.g. red for being very close or a “danger” zone, such as within 2 to 5 meters; yellow for being somewhat close or in a “caution” zone, such as within 5 to 20 meters; and green for being proximate but in a “caution” zone, such as outside of 5 to 20 meters or 50 meters, the distance between the personnel identifier system 200 and the detection subsystem 150, the position of the personnel identifier system 200 relative to the detection subsystem 150, or the displacement of the personnel identifier system 200 relative to the detection subsystem 150.

For example, the detection subsystem 150 includes a communication subsystem 103, for example, a wireless communication subsystem 103, that is configured to detect and determine a proximity of the personnel identifier system 200 and receive the identification of the personnel identifier system 200 from the personnel identifier system 200. For example, each of the one or more detection subsystems 150 includes a respective communication subsystem 103. For example, the communication subsystem 103 may determine the proximity of the personnel identifier system 200 using time-of-flight to the personnel identifier system 200. For example, the proximity of the personnel identifier system 200 may be determined through triangulation between the personnel identifier system 200 and at least two of the wireless communication subsystems 103 from respective detection subsystems 150, for example, based on the direction of the personnel identifier system 200 in relation to two of the detection subsystems 150. The communication subsystem 103 may be configured to receive the identification of the personnel identifier system 200 from the personnel identifier system 200 directly, for example, via a near field communication protocol, Wi-Fi, or Bluetooth, and/or via a peer-to-peer network or communication networks.

For example, at least one of the detection subsystems 150 may be disposed relative to the vehicle system controller 160 such that the at least one detection subsystem 150 may be within the range of a short range communication protocol of the vehicle system 100. For example, at least one of the detection subsystems 150 may be placed out of range of a short range communication protocol of the vehicle system 100, but remains in operable communication with the vehicle system 100.

For example, the detected proximity value by the communication subsystem 103 may have a plurality of possible values. For example, the detected or sensed proximity value includes a plurality of possible non-zero values.

For example, the vehicle system controller 160 is configured to receive the data from the detection subsystem 150, for example, from the communication subsystem 103, for diagnosing the operating status of each of the one or more detection subsystems 150.

FIG. 2 is a schematic of the mining vehicle collision avoidance system 10. As depicted in FIG. 2, for example, the system 10 includes a vehicle system 100 that may be installed on a vehicle 50, such as a mining vehicle 50. As depicted, the vehicle 50 is a loader. For example, the vehicle 50 is another appropriate mining vehicle, such as a utility vehicle, personnel transport, rescue vehicle, haul truck, scaler, grader, rock breaker, road header, and the like. The vehicle 50 may include a cabin 52 in which the controls for operation of the vehicle 50 are disposed. There is often limited visibility of the surroundings for the operator from the mining vehicle 50, and in underground mines it is not possible to see around the corners. Also, mining vehicles 50 are often articulated vehicles and there is a danger of getting squeezed e.g. between the vehicle 50 and a mine wall.

FIG. 2 depicts four detection subsystems 150 disposed on the vehicle 50, one on the front left side of the vehicle 50, one on the front right side of the vehicle 50, one on the rear left side of the vehicle 50, one on the rear right side of the vehicle 50. For example, one or more detection subsystems 150 are disposed on the vehicle 50. For example, the one or more detection subsystems 150 are disposed about the periphery or outer portions of the vehicle 50, such that proximity of a personnel identifier system 200 may be detected before the vehicle 50, which includes the vehicle system 100, collides with the personnel identifier system 200.

As depicted in FIG. 2 and FIG. 3, for example, the detection subsystem 150 has a cylindrical body. For example, the detection subsystem 150 may have a triangular body, quadrilateral body, a polygonal body, and the like.

For example, the one or more detection subsystems 150 may be secured to the vehicle 50 with screws, nuts and bolts, clips, and the like, or using adhesive or welding.

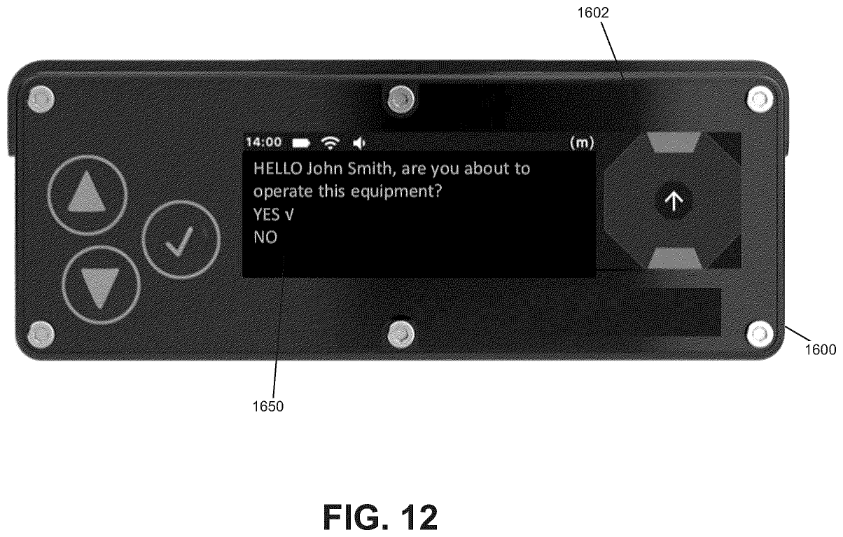

The mining vehicle collision avoidance system 10 may be configurable for inspection before operation of the vehicle 50, in particular, the inspection of the one or more detection subsystems 150. As depicted in FIG. 2, the one or more detection subsystems 150 are configured to be in operable communication with a signal isolator 180, which is in operable communication with a starter interlock 182, an availability switch 184, an operator identification reader 186, the vehicle system controller 160, an actuator 102, and the user interface 1600, for example, via an integrated device network. For example, the isolator 180 may be configured to receive a plurality of signals from the one or more detector subsystems 150 and isolate individual signals of each of the detector subsystems 150. For example, the user, who may be wearing a personnel identifier system 200, such as a cap lamp (a cap and a lamp mounted to the cap), or a cap, lamp, and belt pack, may actuate the availability switch 184, for example, via the actuator 102 to dispose the vehicle system 100 in a downtime mode, and input via the user interface 1600 that the reason for the downtime mode is for pre-operation inspection. The operator may identify themselves prior to changing the state of the machine, and this identifier can be stored, together with the state change information. The identification of the personnel identifier system 200 may be sensed by the operator identification reader, which, for example, is a component of the detection subsystem 150. The vehicle system controller 160 may be configured to, based on the sensing of the identification of the personnel identifier system 200, render a graphic 1650 on the user interface 1600, to ask the operator to provide an input to confirm the identity of the operator, as depicted in FIG. 12. For example, the user may input the identification of the personnel identifier system 200 via the user interface 1600, as depicted in FIG. 12. Then, the user, wearing the personnel identifier system 200, may walk around the vehicle 50, such that the one or more detection subsystems 150 mounted on the vehicle 50 detects the proximity of the personnel identifier system 200. For example, at this time, input means may be provided on the user equipment 400 like an active user interface element for the operator to input the status, such as an operational status, of the one or more detection subsystems 150 to the user equipment 400. Alternatively or in addition, a checklist may be displayed on the user equipment 400 for the user to visually inspect the vehicle 50 and input the status of the vehicle 50 to the user equipment 400. The user equipment 400 may transmit the inputs from the user to the server 300 and/or the vehicle system controller 160. Alternatively or in addition, the operator may input the status, such as the operational status, of the one or more detection subsystems 150 via the personnel identifier system 200, for example, via a user interface 254, such as actuation of one or more buttons. The personnel identifier system 200 may transmit the inputs from the user to the server 300 and/or the vehicle system controller 160.

The vehicle system controller 160 receives the data representative of the proximity of the personnel identifier system 200, for example, from the one or more detection subsystems 150, and the identification of the personnel identifier system 200, and based on said data, diagnose the operating status of the one or more detection subsystems 150. For example, the operating status of the one or more detection subsystems 150 may be determined to be approved for operation when each of the one or more detection subsystems 150 detects that the personnel identifier system 200 is proximate to the respective one or more detection subsystems 150, for example, that the personnel identifier system 200 is outside a first threshold proximity (e.g. outside 10 to 20 meters), within a first threshold proximity (e.g. within 5 or 10 meters), within a second threshold proximity that is less than the first threshold proximity (e.g. 2 or 5 meters), and/or within a threshold inspection proximity (e.g. 2 meters), of the respective one or more detection subsystems 150. For example, the vehicle system controller 160 may diagnose a detection subsystem 150 to be operational if the detection subsystem 150 detects, or is able to detect, that the personnel identifier system 200 is moving closer to the detection subsystem 150, from outside the first threshold proximity to within the threshold inspection proximity. Based on the determination of the operating status of the one or more detection subsystems 150, the vehicle system controller 160 may send a control command to the starter interlock 182. For example, based on the determination that the one or more detection subsystems 150 is approved for operation, the vehicle system controller 160 sends a control command to the starter interlock 182 to enable start-up of the engine or engine subsystem of the vehicle subsystems 170 via actuation of a start button or key switch 188. For example, based on the determination that the one or more detection subsystems 150 is not approved for operation, the vehicle system controller 160 sends a control command to the starter interlock 182 to disable start-up of the engine subsystem. For example, the default setting of the starter interlock 182 may be to disable start-up of the engine subsystem with the start button or key switch 188, and the vehicle system controller 160 sends a control command to the starter interlock 182 to enable engine subsystem start-up in response to completion of the diagnosis of each one of the one or more detection subsystems 150 and determined that each of the one or more detection subsystems 150 is approved for operation. The lighting 112 can be used by the operator to visually determine whether a detector 150 works properly.

The user interface 1600 may be further configured to be in operable communication with a mobile equipment telemetry unit 190, for example, via Ethernet connection. For example, the vehicle system 100 may be configured to be in operable communication with the server 300 via the mobile equipment telemetry unit 190. For example, the data detected or sensed by the detection subsystem 150 during the pre-operational inspection of the vehicle system 100 is transmittable to the server 300 via the mobile equipment telemetry unit 190.

FIG. 3 is another schematic of the vehicle collision avoidance system 10.

The vehicle collision avoidance system 10 may be configurable to actuate the brake system, for example, during inspection before operation of the vehicle system 100. As depicted in FIG. 3, the one or more detection subsystems 150 are configured to be in operable communication with the signal isolator 180, which is in operable communication with a park brake release interlock 192 of the vehicle subsystems 170, the vehicle system controller 160, and the user interface 1600, for example, via an integrated device network. For example, the user, who may be wearing a personnel identifier system 200, for example, a cap lamp (a cap, and a lamp mounted to the cap), and belt pack, may actuate the availability switch 184 to dispose the vehicle system 100 in a downtime mode, and input via the user interface 1600 that the reason for the downtime mode is for pre-operation inspection. The identification of the personnel identifier system 200 may be sensed by the operator identification reader, which, for example, is a component of the detection subsystem 150. For example, the user may input the identification of the personnel identifier system 200 via the user interface 1600. Then, the user, wearing the personnel identifier system 200, may walk around the vehicle system 100, such that the one or more detection subsystems 150 may detect the proximity of the personnel identifier system 200. For example, at this time, input means may be provided on the user equipment 400 like an active user interface element for the operator to input the status, such as an operational status, of the one or more detection subsystems 150 to the user equipment 400. Alternatively or in addition, a checklist may be displayed on the user equipment 400 for the user to visually inspect the vehicle 50 and input the status of the vehicle 50 to the user equipment 400. The user equipment 400 may transmit the inputs from the user to the server 300 and/or the vehicle system controller 160. Alternatively or in addition, the operator may input the status, such as the operational status, of the one or more detection subsystems 150 via the personnel identifier system 200, for example, via a user interface 254, such as actuation of one or more buttons. The personnel identifier system 200 may transmit the inputs from the user to the server 300 and/or the vehicle system controller 160.

The vehicle system controller 160 receives the data representative of the proximity of the personnel identifier system 200, for example, from the one or more detection subsystems 150, and the identification of the personnel identifier system 200, and based on said data, diagnose the operating status of the one or more detection subsystems 150. For example, the operating status of the one or more detection subsystems 150 may be determined to be approved for operation when each of the one or more detection subsystems 150 detects that the personnel identifier system 200 is proximate to the respective one or more detection subsystems 150, for example, that the personnel identifier system 200 is outside a first threshold proximity (e.g. outside 10 or 20 meters), within a first threshold proximity (e.g. within 10 or 20 meters), within a second threshold proximity that is less than the first threshold proximity (e.g. 2 or 5 meters), and/or within a threshold inspection proximity (e.g. 2 or 5 meters), of the respective one or more detection subsystems 150. For example, the vehicle system controller 160 may diagnose a detection subsystem 150 to be operational if the detection subsystem 150 detects, or is able to detect, that the personnel identifier system 200 is moving closer to the detection subsystem 150, from outside the first threshold proximity to within the threshold inspection proximity. Based on the determination of the operating status of the one or more detection subsystems 150, the vehicle system controller 160 may send a control command to the park brake release interlock 192. For example, based on the determination that the one or more detection subsystems 150 is approved for operation, the vehicle system controller 160 sends a control command to the park brake release interlock 192 to release the park brake via the park brake release switch 194. For example, based on the determination that the one or more detection subsystems 150 is not approved for operation, the vehicle system controller 160 sends a control command to the park brake release interlock 192 to disable release of the park brake. For example, the default setting of the park brake release interlock may be to disable release of the park brake, and the vehicle system controller 160 may send a control command to the park brake release interlock 192 to enable release of the brake in response to completion of the diagnosis of each one of the one or more detection subsystems 150 and determined that each of the one or more detection subsystems 150 is approved for operation.

The vehicle collision avoidance system 10 may be configurable to actuate the brake system, for example, during operation of the vehicle 50. During operation of the vehicle 50, the one or more detection subsystems 150 may be detecting data representative of a personnel identifier system 200, for example, one that is on a cap lamp (cap with a lamp mounted thereon) or one that is mounted to another vehicle (not shown here). When the personnel identifier system 200 becomes proximate to the vehicle system 100, the one or more detection subsystems 150 may detect the personnel identifier system 200, and may determine the proximity of the personnel identifier system 200. The one or more detection subsystems 150 sends the data representative of the proximity of the personnel identifier system 200 to the vehicle system controller 160. Based on the proximity of the personnel identifier system 200 relative to the vehicle system 100, the vehicle system controller 160 may send a control command to the park brake release interlock 192. For example, in response to the one or more detection subsystems 150 determining that the personnel identifier system 200 is within a first threshold proximity such as an “alarm” zone, the vehicle system controller 160 sends a control command to the park brake release interlock 192 to actuate the brake subsystem to slow the vehicle 50. As another example, in response to the one or more detection subsystems 150 determining that the personnel identifier system 200 is within a second threshold proximity that is closer than the first threshold proximity such as an “danger” zone, the vehicle system controller 160 sends a control command to the park brake release interlock 192 to actuate the brake subsystem to stop the vehicle 50, for example, an emergency stop of the vehicle 50.

The user interface 1600 may be further configured to be in operable communication with the mobile equipment telemetry unit 190, for example, via Ethernet connection. For example, the vehicle system 100 may be configured to be in operable communication with the server 300 via the mobile equipment telemetry unit 190. For example, the data detected or sensed by the detection subsystem 150 during pre-operation inspection or operation of the vehicle system 100 and/or the vehicle 50 may be transmittable to the server 300 via the mobile equipment telemetry unit 190.

For example, to provide electrical energy to the vehicle system 100, the vehicle system 100 may include one or more batteries, and may be configured to be in electrical communication with the components of the vehicle system 100 to power the vehicle system 100. For example, one of the batteries may be configured to provide power to some of the components of the vehicle system 100, while another of the batteries may be configured to provide power to other of the components of the vehicle system 100. For example, one of the batteries may be configured to provide power to the vehicle system controller 160, the memory 130, the user interface 1600, and the one or more detection subsystems 150 of the vehicle system 100, while another of the batteries may be configured to provide power to the vehicle subsystems 170. For example, said one or more batteries may be the one or more batteries of the vehicle 50.

For example, the vehicle system 100 includes a vehicle system controller 160. The vehicle system controller 160 is in operable communication with the one or more detection subsystems 150, the user interface 1600, the vehicle and the memory 130. The vehicle system controller 160 is for executing instructions stored in the memory 130 that, when executed, causes the vehicle system controller 160 to receive, from the one or more detection subsystems 150, the data representative of the proximity of the personnel identifier system 200, receive, from the personnel identifier system, the data representative of the identification of the user, and based on the determination of the proximity of the personnel identifier system 200 relative to the one or more detection subsystems 150 and the identification of the personnel identifier system 200, diagnose an operating status of each of the one or more detection subsystems 150.

For example, the vehicle system controller 160 may be configured to receive, from the one or more detection subsystems 150, the data representative of the proximity of the personnel identifier system 200, determine, based on the data representative of the proximity of the personnel identifier system 200, the proximity of the personnel identifier system 200 relative to the one or more detection subsystems 150, receive, from the personnel identifier system 200, the data representative of the identification of the personnel identifier system 200, and based on the determination of the proximity of the personnel identifier system 200 relative to the one or more detection subsystems 150 and the identification of the personnel identifier system 200, diagnose an operating status of each of the one or more detection subsystems 150. In this regard, the vehicle system controller 160 may be configured to determine that it is a certain operator, namely the operator wearing the personnel identifier system 200, that is conducting the inspection of the vehicle 50 and the vehicle system 100, and the vehicle system controller 160 would not determine that another operator, for example, a passerby, wearing another personnel identifier system 200, is conducting the inspection. The vehicle system controller 160 may be configured to allow the same operator that inspected the vehicle 50 and the vehicle system 100 to operate the vehicle 50. Alternatively or in addition, the vehicle system controller 160 may be configured to ready the vehicle 50 for operation when the operator wearing the personnel identifier system 200 who has conducted the vehicle inspection enters the vehicle 50. This may allow the inspection of the vehicle 50 and the vehicle system 100 to be conducted in relatively narrow spaces, where other operators may pass by the inspecting operator while the inspecting operator is inspecting the vehicle 50 and the vehicle system 100. In addition, since the one or more detection subsystems 150 and the personnel identifier system 200 are communicating directly or via a network, walls or other obstacles may not disturb said communication.

For example, based on the determination of the operating status of the one or more detection subsystems 150, the vehicle system controller 160 may send a control command to one of the vehicle subsystems 170 to control the functioning of said one or more vehicle subsystems 170.

For example, the memory 130 may be rewritable memory.

For example, the vehicle system controller 160 may be mounted to the vehicle 50, for example, the frame, chassis, or body of the vehicle 50. For example, the vehicle system controller 160 may diagnose the operating status of each of the one or more detection subsystems 150, and may enable or disable start-up of the engine or may bind or unbind the brake system depending on the outcome of the diagnosis of the operating status of each of the one or more detection subsystems 150. For example, the power management circuitry, the vehicle system controller 160, and the memory 130 may be mounted or printed on a circuit board. For example, the communication subsystem 103 for wireless communication may mounted or printed on a circuit board and in the body of the respective detection subsystem 150. The communication subsystem 103 may be configured for communication via a number of suitable standards, such as Bluetooth Low Energy, Wi-Fi, cellular, peer-to-peer, leaky feeder etc.

For example, the vehicle system 100 may include one vehicle system controller 160. For example, the vehicle system 100 may include more than one vehicle system controller 160, with the vehicle system controllers 160 configured to control different functions of the vehicle system 100. For example, one or more vehicle system controllers 160 may be configured to receive the data from corresponding one or more detection subsystems 150, another vehicle system controller 160 may be configured to diagnose the operating status of the one or more detection subsystems 150, and another vehicle system controller 160 may be configured to send control commands to the user interface 1600 and vehicle subsystems 170.

FIG. 4 depicts an example configuration of the vehicle system 100. As depicted, for example, the vehicle system 100 may include a vehicle system controller 160, one or more detection subsystems 150, memory 130, power module 107, user interface 1600, and vehicle subsystems 170. For example, the vehicle system 100 may be configured to be in electrical communication with a battery. For example, the vehicle system 100 may be disposable in electrical connection with a power source, such as a portable battery, portable generator, external battery, battery of the vehicle 50, and the like. For example, the vehicle system 100 may be wirelessly connectable to the power source for wirelessly energizing the vehicle system 100.

For example, the vehicle system controller 160 may include a processor or a central processing unit (CPU), a memory 130 such as a ROM, RAM, persistent memory, or flash memory for storing data, and input or output peripherals. The vehicle system controller 160 may act as a central controller for controlling all of the communications of the vehicle system 100, the personnel identifier system 200, the server 300, and the user equipment 400. For example, the vehicle system 100 may have a vehicle system identifier, such a Media Access Control (MAC) address paired with a unique serial identification number, which may be stored in the memory 130, for example. The MAC address and serial number may uniquely identify the vehicle system 100 on the system 10. For example, the MAC address may be included in each communication between the vehicle system 100 and the server 300, and between the vehicle system 100 and the user equipment 400, to identify the vehicle system 100. For example, the vehicle system 100 may communicate directly with the personnel identifier system 200 and user equipment 400 via wireless communications, such as with the Wi-Fi, Bluetooth, or cellular radio function. For example, the vehicle system 100 may act as a hub to other vehicle systems 100 or the personnel identifier system 200, or acting as a hot-spot for the vehicle system 100 or the personnel identifier system 200. For example, in response to a communication received from the server 300, the vehicle system controller 160 may communicate with the server 300 using a RESTful API, which is a set of Hypertext Transfer Protocol (HTTP) POST and GET requests. For example, the vehicle system controller 160 may communicate with the server 300 with the RESTful API to configure a Wi-Fi (Wireless Fidelity) network. For example, the vehicle system controller 160 may communicate with the server 300 using a web sockets, long polling sockets, or message queuing telemetry transport (MQTT).

The vehicle system controller 160 may communicate with the personnel identifier system 200, the server 300, and/or the user equipment 400 via the communication subsystem 103 of the detection subsystem 150. For example, the vehicle system controller 160 may receive data from the personnel identifier system 200 and/or from the detection subsystem 150, save the data to a memory, and process the received data. The data may be real time data or historical data. For example, the vehicle system controller 160 may process the data by, for example, comparing data with one or more preset thresholds. For example, the vehicle system controller 160 or detection subsystem 150 may process the data by, for example, calculating or determining the number of detection subsystems 150 that detected that the personnel identifier system 200 was proximate, the distance between the personnel identifier system 200 and the one or more detection subsystems 150, the relative position of the personnel identifier system 200 to the one or more detection subsystems 150, the relative displacement of the personnel identifier system 200 to the one or more detection subsystems 150, the detecting sequence of the one or more detection subsystems 150, and the duration of detection of the one or more detection subsystems 150. Based on said calculation or determination, the vehicle system controller 160 may be configured to diagnose an operating status of each of the one or more detection subsystems 150. For example, the vehicle system controller 160 may send the results of the processed data to the personnel identifier system 200, server 300, or user equipment 400 via the communication subsystem 103, for example, the Wireless Wide Area Network (WWAN) module 106, RF ID module 108, Wi-Fi module 110, or Bluetooth module 111. For example, the vehicle system controller 160, based on the diagnosis of each of the one or more detection subsystems 150, may variably control one or more vehicle subsystems 170 of the vehicle system 100, for example, by enabling start-up of the engine or unbinding the brake system.

For example, the vehicle system controller 160 may be configured to upload the data received from the one or more detection subsystems 150 or the personnel identifier system 200, or the processed data based on the received data, to the server 300, through the communication subsystem 103. For example, the vehicle system controller 160 may send data, including the detected or received data from the one or more detection subsystems 150 or from the personnel identifier system 200, to the server 300 periodically, such as once every hour, to update the server 300 with, for example, the proximity of the personnel identifier system 200, relative position or displacement of the personnel identifier system 200 relative to the one or more detection subsystems 150, operational status of the vehicle system 100, light output of the lighting subsystem 112, status of the vehicle subsystems 170 and the user interface 1600, among other information. For example, such data, for example, detected from the one or more detection subsystems 150 or from the personnel identifier system 200, may then be transmitted from the server 300 to the user equipment 400 (e.g. push or pull). For example, as a default, wireless communications between the vehicle system 100 and the server 300 may use the WWAN, or a Wi-Fi network, or may bypass (do not use or require) any Wi-Fi Network.

In some examples, the data that is uploaded may include the MAC address and a serial identification number of the vehicle system 100 to identify the vehicle system 100, and the identification for the personnel identifier system 200, such as the MAC address and the serial number of the personnel identifier system 200 or the identification of the personnel identifier system 200, to identify the vehicle system 100 or the personnel identifier system 200 that has generated the sensed or detected data or was the origin or source of the data. The data may be contained in one or more communications. Some of the data, for example the identification of the vehicle system 100 or the personnel identifier system 200 and the MAC address, may be contained in a header of a communication (e.g. HTTP communication), while the data relating to the value of the detected or sensed data or the data representative of the personnel identifier system 200 can be the payload of the HTTP communication. Other example triggers for sending the data may be as follows: the vehicle system controller 160 may also send the data from the detection subsystem 150 or the personnel identifier system 200 when the power loss is detected, when the detection subsystem 150 detects that a personnel identifier system 200 is within a first or second threshold proximity, when inspection of the vehicle 50 is complete and approved, when the vehicle 50 is started, or before starting the vehicle 50 when an operator enters the vehicle 50. For example, the server 300 may store the received data or the processed data from the vehicle system 100. For example, the server 300 may communicate the data or the processed results to the user equipment 400 according to the preference of the user, for example, via emails, push notification, and the like.

For example, the vehicle system controller 160 may be configured to control the functioning or operation of the vehicle system 100 and/or the vehicle 50. For example, based on the data from the detection subsystems 150 or from the personnel identifier system 200, the vehicle system controller 160 may send a control command to the user interface 1600 to render a graphic representative of the data, or may send a control command to a starter interlock of the vehicle subsystems 170 to disable start-up of the engine, or may send a control command to the park brake release interlock of the vehicle subsystems 170 to actuate or unactuated the brake system.

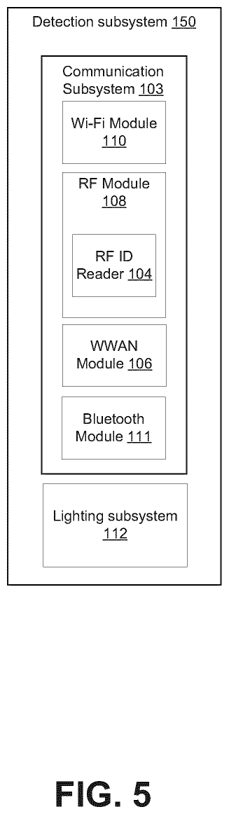

The vehicle system 100 includes one or more detection subsystems 150, for example, two or more detection subsystems 150. Each of the one or more detection subsystems including a respective wireless communication subsystem, configured to determine a proximity of a personnel identifier system 200 and receive the identification of the personnel identifier system from the personnel identifier system 200. As depicted in FIG. 5, the detection subsystem 150 may include a communication subsystem 103 (which includes a Wi-Fi module 110, an RF module 108 and an RF ID reader 104, a WWAN module 106, and a Bluetooth module 111), and a lighting subsystem 112. For example, the communication subsystem 103 of the vehicle system 100 and the communication subsystem 203 of the personnel identifier system may be co-operatively configured for direct communication, for example, peer-to-peer communication.

The communication subsystem is configured to determine a proximity of the personnel identifier system 200 and receive the identification of the personnel identifier system 200 from the personnel identifier system 200. For example, the communication subsystem 103 may include a range communication, for example, short range, medium range, or long range communication, that may be used to determine that a personnel identifier system 200 is placed in proximity to the vehicle system 100. For example, the vehicle system controller 160 may be configured to detect the personnel identifier system 200 via the detection subsystem 150 using a short range communication protocol. For example, said short range communication protocol may be a radio-frequency identification (RFID) protocol or a near field communication (NFC) protocol. For example, the communication protocol for establishing communication between the vehicle system 100 and the personnel identifier system 200 may be such that the distance between the vehicle system 100 and the personnel identifier system 200 and the duration that said distance is maintained is determinable via the communication protocol. As depicted in FIG. 5, For example, the communication subsystem 103 may include a radiofrequency identification (RF ID) reader 104, a WWAN module 106, an RF module 108, a Wi-Fi module 110, and a Bluetooth module 111.

For example, the detection subsystem 150 and the personnel identifier system 200 may be configured to communicate via ultra-wide-band (UWB) communication. For example, the personnel identifier system 200 transmits a UWB signal that carries the identification to the detection subsystem 150. In this respect, a collision avoidance communication includes the identification of the collision avoidance unit (for example, the personnel identification system 200 is a cap lamp or another device operating as a collision avoidance unit).

For example, the detection subsystem 150 and the personnel identifier system 200 may be configured to communicate via RFID. An RFID tag may function as a transponder employing back-scattering modulation of the RFID reader's signal.

For example, the proximity of the personnel identifier system 200 may be determined based on time of flight of the signals of the communication protocol, such as Wi-Fi, Bluetooth, or RFID signals.

For example, based on the time of flight of the signals of the communication protocol, the vehicle system controller 160 may be configured to determine the proximity of the personnel identifier system 200 relative to the one or more detection subsystems 150. For example, the one or more detection subsystems 150 may generate a signal representative of a proximity of the personnel identifier system 200, or the distance between the detection subsystem 150 and the personnel identifier system 200.

For example, the data representative of an identification of the transmitted by the personnel identifier system 200 may include a time stamp. Based on the time stamp of the data transmitted from the personnel identifier system 200, the one or more detection subsystems 150 may be configured to determine the time for the data to be transmitted to the one or more detection subsystems 150, and based on said determination, may determine the proximity of the personnel identifier system 200 relative to the one or more detection subsystems 150.

In such examples, the vehicle system controller 160 is configured to receive, from the detection subsystem 150, data representative of a personnel identifier system's 200 proximity detected by the detection subsystem 150, and based on said data and data representative of the identification of the personnel identifier system, diagnose an operating status of each one of the one more detection subsystems 150.

For example, the determining of the proximity of the personnel identifier system 200 may be performed through each respective communication subsystem 150, which is a wireless communication subsystem for example, using time-of-flight to the personnel identifier system 200. For example, the determining of the proximity of the personnel identifier system 200 may be performed through triangulation between the personnel identifier system 200 and at least two of the communication subsystems 103 of respective detection subsystems 150.

For example, the communication subsystem 103 may include an omnidirectional antenna or multi-array antenna for transmitting or receiving data and other information, for example, data representative of the proximity of the personnel identifier system 200, identification of the personnel identifier system 200, and proximity warnings.

For example, the communication subsystem 103 includes a Wireless Wide Area Network (WWAN) module 106, that functions as a wireless communication module, or a wireless communication subsystem, for the vehicle system 100 to access standard wireless communications services, such as communications services provided by GSM, GPRS, 3G, 4G LTE, and 5G wireless networks, and for establishing communication between the vehicle system 100, the personnel identifier system 200, the server 300, and the user equipment 400. The vehicle system controller 160 controls the communication subsystem 103. For example, the RF module 108 includes the RF ID reader 104. For example, the communication subsystem 103 includes a wireless communication subsystem.

The RF ID reader 104 reads or detects the identifier uniquely associated with each of the personnel identifier system 200, for example, from a RF ID, an NFC tag, and the like, while the personnel identifier system 200 is proximate with the vehicle system 100, for example, while the personnel identifier system 200 is within 1 meter, for example, some centimeters or tens of centimeters of the vehicle system 100. In some examples, the RF ID reader 104 may the identification read from the personnel identifier system 200 to the vehicle system controller 160 for the vehicle system 100 to recognize the personnel identifier system 200 and for the vehicle system 100 to store the identifiers in the memory 130 of the vehicle system 100. The vehicle system controller 160 then registers the personnel identifier system 200 with the vehicle system 100 based on their respective RF identifiers. In other words, with the RF identifiers, the vehicle system 100 may recognize a respective personnel identifier system 200. The personnel identifier system 200 may send its identifier (e.g. alphanumeric 9 digit code or the Media Access Control (MAC) address) to the vehicle system 100 via any near field communications modules, such as infrared or Bluetooth™.

RF module 108 may allow the vehicle system 100 to transmit and/or receive data in the form of wireless signals with the corresponding RF module 208 of the personnel identifier system 200, using for example unlicensed frequency spectrum, for example on 915 MHz band. Example embodiments that refer to the unlicensed frequency spectrum can also be applied to one unlicensed frequency channel. The RF module 108 may include power amplifying circuits for amplifying the RF signals, and frequency modulation circuits for modulating the signals to the selected radio frequency, and antennas for the RF signals to be radiated to the personnel identifier system 200 or to receive the RF signals from the personnel identifier system 200. For example, the data transmitted and/or received between the RF module 108 of the vehicle system 100 and the RF module 208 of the personnel identifier system 200 may be transmitted and/or received via a short range communication protocol, such as a radio-frequency identification (RFID) protocol or a near field communication (NFC) protocol, executed by the RF module 108 and the RF module 208.

The Wi-Fi module 110 may provide circuits that enable the vehicle system 100 to use Wi-Fi networks and to transmit data to the server 300, user equipment 400, or the personnel identifier system 200, and to receive data from the server 300, user equipment 400, or personnel identifier system 400. For example, the Wi-Fi module 110 may include a Wi-Fi transceiver. For example, a user uses the user equipment 400 to configure the Wi-Fi module 110 via the server 300, for example, via a cloud based web-portal.

For example, the Wi-Fi module 110 may scan available Wi-Fi networks, and connects the vehicle system 100 to a selected Wi-Fi network. For example, the Wi Fi module 110 detects loss of the Wi-Fi networks and loss of the Internet connection. For example, the Wi-Fi module 110 makes HTTP request over SSL and open a TCP socket over SSL so that the Wi-Fi module 110 may access a webpage using TCP/IP protocol. In some examples, all of the communications between the vehicle system 100 and the server 300 may be encrypted. For example, the encryption is transport layer security (TLS) encryption.

For example, the Wi-Fi module 110 may be configured to be in operable communication with a wireless router for communication with the personnel identifier system 200, for example, via a wireless local area network.

For example, the communication subsystem 103 may include a Bluetooth module 111, that functions as a wireless communication module, or a wireless communication subsystem, for the vehicle system 100 to communicate via Bluetooth wireless communication protocol, and for establishing communication between the vehicle system 100, the personnel identifier system 200, the server 300, and the user equipment 400.

As depicted in FIG. 2, FIG. 3, and FIG. 5, For example, the detection subsystem 150 may include a lighting subsystem 112. For example, the lighting subsystem 112 includes a light output, for example a variable light output, such as a light strip, and a light diffuser. For example, the light strip includes a plurality of RGB LEDs. For example, the light diffuser is a plastic light diffuser. For example, the lighting subsystem 112 is in operable communication with the vehicle system controller 160, such that a control command may be transmitted to the lighting subsystem 112 to activate, for example, variably activate, the light output of the lighting subsystem 112 and for the lighting subsystem 112 to illuminate a certain colour or animation. For example, the variable light output of the respective lighting subsystem 112 may be activatable corresponding to the diagnosing of different operating statuses of the respective detection subsystem 150.

For example, based on the determination that the detection subsystem 150 is approved for operation, the vehicle system controller 160 may send a control command to the respective lighting system 112 for the lighting subsystem 112 to illuminate a certain colour or animation, such as a blue colour. For example, based on the determination that the detection subsystem 150 is not approved for operation, the vehicle system controller 160 may send a control command to the respective lighting system 112 for the lighting subsystem 112 to illuminate a certain colour or animation, such as an orange colour.

For example, based on the determination that no personnel identifier system 200 is proximate a respective detection subsystem 150, the vehicle system controller 160 may send a control command to the corresponding lighting subsystem 112 of the respective detection subsystem 150 for the lighting subsystem 112 to illuminate a certain colour or animation, such as a white colour, such that the detection subsystem 150 functions to illuminate the surrounding area.

For example, based on the determination that the personnel identifier system 200 is within a first threshold proximity of a respective detection subsystem 150, for example, representative of being within an alarm zone, the vehicle system controller 160 may send a control command to the corresponding lighting subsystem 112 of the respective detection subsystem 150 for the lighting subsystem 112 to illuminate a certain colour or animation, such as a yellow colour.

For example, based on the determination that the personnel identifier system 200 is within a second threshold proximity of a respective detection subsystem 150 that is less than the first threshold proximity, for example, representative of being within a danger zone, the vehicle system controller 160 may send a control command to the corresponding lighting subsystem 112 of the respective detection subsystem 150 for the lighting subsystem 112 to illuminate a certain colour or animation, such as a red colour.

For example, based on the determination that the personnel identifier system 200 is outside a first threshold proximity of a respective detection subsystem 150, for example, representative of being within a caution zone or outside an alarm zone, the vehicle system controller 160 may send a control command to the corresponding lighting subsystem 112 of the respective detection subsystem 150 for the lighting subsystem 112 to illuminate a certain colour or animation, such as a green colour.

Example animations that are displayed by the lighting subsystem 112 include fading in, fading out, blinking, and the like.

The light output of the lighting subsystem 112 of the detection subsystem 150 may allow for visual observation that the detection subsystem 150 is detecting or able to: 1) detect the personnel identifier subsystem 200, and/or 2) detect the personnel identifier subsystem 200 outside of the first threshold proximity or within the first, second, or inspection threshold proximity. The different lights and/or distance ranges may be recorded by the system 10 and such a recording can be used to determine that the operator has in fact been close to the detection subsystem 150. This provides good trackability of the inspection process and such data can be stored for later use e.g. at the vehicle 50 or at the server 300.

For example, the power module 107 may include a power detection circuit, such as a power detector, to determine when outlet power is lost. The power detector may be a presence/absence power detector, for example. For example, the power detector measures the specific signal from the power source, such as the battery of the vehicle system 100 (e.g., power, voltage, or current). When the input power from the power source is lost, drops below a threshold, or is fluctuating, a battery backup is configured to seamlessly supply power to the vehicle system 100, for example, by the rechargeable battery. Typically, the rechargeable battery may be capable of supplying power the vehicle system 100 for at least 24 hours. For example, the vehicle system controller 160 may report the remaining power of the battery to the server 300 and the user equipment 400. When the power is lost, the vehicle system controller 160 reports the power loss to the server 300 as an alert event, for example via HTTP request and/or to the user equipment 400 via emails, text messages, or push notification. For example, the vehicle system 100 uses the WWAN module 106 or Wi-Fi module 110 to transmit the data received from the detection subsystem 150 or the personnel identifier system 200 to the server 300, the RF module 108 remains active for receiving messages, such as anomalies, from the detection subsystem 150 or the personnel identifier system 200.

For example, the power module 107 may include a charging circuit, and a battery backup. The charging circuit may receive the power from a power source disposed in the premises, such as an electrical outlet or the battery of the vehicle 50, converts the received power to appropriate voltage and current, and supplies the converted power to various elements of the vehicle system 100. For example, the battery backup includes a rechargeable battery. For example, the charging circuit supplies the converted power to the battery backup for charging the rechargeable battery, the vehicle system controller 160, and communication subsystem 103, the one or more detection subsystems 150, the user interface 1600, the vehicle subsystems 170. For example, the charging circuit supplies the converted voltage and current to the battery backup for charging the rechargeable battery, and the rechargeable battery of the battery backup supplies power to the vehicle system 100, such as the vehicle system controller 160, and communication subsystem 103, the one or more detection subsystems 150, the user interface 1600, the vehicle subsystems 170. For example, the power module 107 may include a switch to turn on or off of the vehicle system 100.

For example, when the input power from the power outlet is lost, the vehicle system 100 may operate in a sleep mode, in which the vehicle system controller 160 turns off the communication subsystem 103 and only activates the one or more elements of the communication subsystem 103 when necessary, and/or periodically.

For example, the vehicle system 100 may include a user interface 1600 that is configured to enable the vehicle system controller 160 to interconnect with one or more input devices, such as a keyboard, mouse, camera, touch screen and a microphone, or with one or more output devices such as a display screen and a speaker. For example, the vehicle system controller 160 may be configured to send a control command to the user interface 1600 for displaying a graphical representation of data that is detected or sensed by the detection subsystem 150. For example, the user interface 1600, via input from a user, may be configured to send a control command to the vehicle system controller 160 for controlling the vehicle system 100.

For example, as depicted in FIG. 2, a user has actuated an availability switch to put the machine down. In response, the vehicle system controller 160 may be configured to send a control command to the user interface 1600 to depict a menu of reasons for the cause of the downtime, and the user may select the reason for the cause of the downtime via the user interface 1600. In response to selection by the user, the user interface 1600 may send a control command to the vehicle system controller 160 to configure the vehicle system 100. For example, in response to user input that the reason for the downtime is to inspect the vehicle system 100, the user interface 1600 sends a control command to the vehicle system controller 160, which, in response, sends a control command to the vehicle subsystems 170 to operate the vehicle system into an inspection mode.

For example, as depicted in FIG. 3, the one or more detection subsystems 150 is receiving data representative of the proximity of one or more personnel identifier systems 200 and determining, based on the data representative of the proximity of the personnel identifier system 200, the proximity of the personnel identifier system 200 relative to the one or more detection subsystems 150. The one or more detection subsystems 150 may send a control command to the vehicle system controller 160 based on the data representative of the proximity of the personnel identifier system 200, and in response, the vehicle system controller 160 may send a control command to the user interface 1600 to displaying a graphical representation of data that is detected or sensed by the detection subsystem 150.

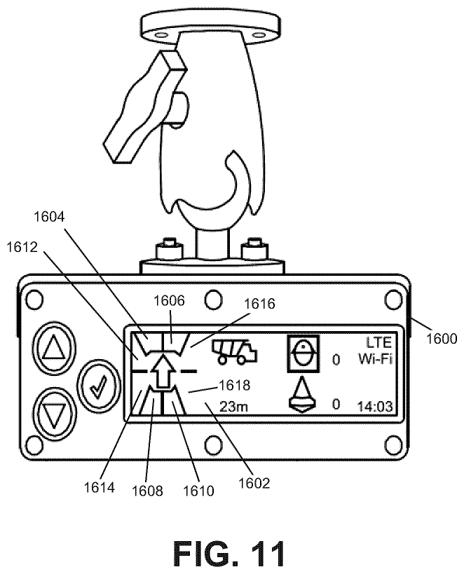

For example, the user interface 1600 may depict a graphical representation 1602 of the area around the vehicle system 100, the area divided into eight segments-front left 1604, front right 1606, left side front 1612, left side rear 1614, right side front 1616, right side rear 1618, rear left 1608, and rear right 1610, as depicted in FIG. 3 and FIG. 11. For example, the detection subsystem 150 may detect a personnel identifier system 200 that is in front of the vehicle 50, and disposed within a first threshold proximity (e.g. representative of a personnel identifier system 200 that is somewhat close to the vehicle system 100; an “alarm” zone), but outside of a second threshold proximity (e.g. representative of a personnel identifier system 200 that is very close to the vehicle system 100; a “danger” zone). In such an example, the vehicle system controller 160 may send a control command to the user interface 1600 to display the front left 1604 and front right 1606 segments in a first colour, such as a yellow colour. As another example, the detection subsystem 150 may detect a personnel identifier system 200 that is to the rear and left of the vehicle 50, and disposed within the second threshold proximity. In such an example, the vehicle system controller 160 may send a control command to the user interface 1600 to display the rear left segment 1608 in a second colour, such as a red colour. As another example, the detection subsystem 150 may detect a personnel identifier system 200 that is disposed outside of the first threshold proximity (e.g. a “caution” zone). In such an example, the vehicle system controller 160 may send a control command to the user interface 1600 to display the corresponding segment in a green colour. As another example, where no personnel identifier system 200 is detected to be proximate the vehicle system 100 in a particular direction, no colour may be rendered in the corresponding segment.

As depicted in FIG. 12, for example, detection subsystems 150 on a front side and rear side of the vehicle system 100 detects an object or a personnel identifier system 200 outside of the first threshold proximity and in a caution zone. In such an example, the vehicle system controller 160 may send a control command to the user interface 1600 to render a graphical representation 1602 of the area around the vehicle system 100 to display the corresponding front and rear segments in a green colour.

The division of the surroundings may also follow another pattern. For example, the surroundings may be formed as a circle or ring, and there may be a number N segments of the 360 degrees around the vehicle, for example, 2, 4, 6 or 8 segments or more. FIG. 12 depicts a graphical representation 1602 of the surroundings divided into 8 segments. The segments may correspond to one or more of the detection sub-systems 150, e.g. such that when two detection sub-systems 150 detect the personnel identifier system 200, a segment between the two detection sub-systems 150 is indicated to be the location of the personnel identifier system 200.

For example, the vehicle system controller 160 may send a control command to the user interface 1600 to display a graphic representative of the identification of the personnel identifier system 200, such as an operator name or number.

For example, the user interface 1600 may include a microphone to receive voice commands from a user. For example, the microphone is in operable communication with an analog to digital converter, such that analog wave representative of a voice command are converted into digital data. For example, the digital data is filtered and segmented, and compared with a library of data representative of known words and phrases, for converting the voice command into a digital command that is transmittable to the vehicle system controller 160 and processable by the vehicle system controller 160.

The lights 112 may also be lit up by the controller 160. The lights may not be part of the same user interface 1600, and the lights 112 may be locally controlled by each detection sub-system 150 or centrally controlled by the controller 160.

For example, the vehicle 50 comprises one or more vehicle subsystems 170, such as a steering subsystem, a brake subsystem, an engine subsystem, an engine start-up subsystem, vehicle system lighting subsystem, and the like. For example, the vehicle system controller 160 may be configured to be in operable communication with the one or more vehicle subsystems 170 vehicle 50 to send control commands to the one or more vehicle subsystems 170 to control the function or operation of the one or more vehicle subsystems 170, for example, in response to the diagnosis of the operating status of each of the one or more detection subsystems 150 based on the determination of the proximity of the personnel identifier system 200 relative to the one or more detection subsystems and the identification of the personnel identifier system 200.

For example, the detection subsystem 150 may include a sensor subsystem that operates through the communication subsystem 103. The sensor subsystem may be in operable communication with the vehicle system controller 160, for example, integrated within the body of the detection subsystem 150.

An example sensor of the sensor subsystem is an occupancy detection sensor (e.g. optical sensor, camera, time of flight sensor, passive infrared detection sensor, radar-based sensor, LIDAR-based sensor, etc.) that is configured to detect the distance, range, presence, or proximity of an object relative to the vehicle system 100. For example, the sensor subsystem includes one or more of such sensors.

For example, one or more of the sensors of the sensor subsystem may be wireless sensors that are configured for wireless communication.

For example, the sensor subsystem may be configured to continuously sense or detect for the proximity of the personnel identifier system 200 relative to the detection subsystem 150. For example, the sensor subsystem, through the communication subsystem 103, may be configured to determine the proximity of the personnel identifier system 200 relative to the detection subsystem 150. In this regard, For example, the detection subsystem 150 has two ways of detecting the proximity of the personnel identifier system 200 relative to the detection subsystem 150, namely, 1) the communication subsystem 103 via Wi-Fi, Bluetooth, and RFID, and 2) the one or more sensors of the sensor subsystem.

For example, the vehicle system controller 160 may receive data representative of the proximity of the personnel identifier system 200 for diagnosing an operating status of each of the one or more detection subsystems 150 from the communication subsystem 103, from the sensor subsystem, or from both the communication subsystem 103 and the sensor subsystem.

For example, the vehicle system controller 160 may receive data representative of the proximity of the personnel identifier system 200 for diagnosing an operating status of each of the one or more detection subsystems 150 only from the communication subsystem 103, and not from a sensor of a sensor subsystem.

For example, it may be the server 300 that processes the data as detected by the detection subsystem 150, for example, the communication subsystem 103, diagnoses the operating status of each of the one or more detection subsystems 150, and sends a control command to the lighting subsystem 112, the user interface 1600, or the vehicle subsystems 170 to control the function of the lighting subsystem 112, the user interface 1600, or the vehicle subsystems 170. For example, said information and data is transmitted to the server 300 by the controller 160.

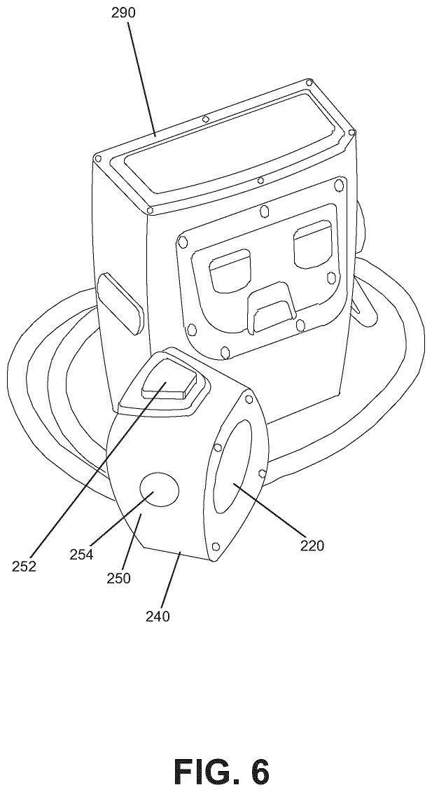

FIG. 6 depicts an embodiment of a personnel identifier system 200. For example, the personnel identifier system 200 may include or be incorporated in a cap and a lamp mounted to the cap. As depicted, the personnel identifier system 200 is a cap lamp 240, or a cap lamp 240 and belt pack 290 that is wearable by an operator. For example, the personnel identifier system 200 is a standalone tag that is disposable on an object, such as an operator, a building, or a vehicle, as depicted in FIG. 3.

For example, the personnel identifier system 200 may include a housing 250, a lighting subsystem 220, and a switch or button 252 for variably activating the lighting subsystem 220 or to modulate the lighting subsystem 220 (e.g. blink, flash, etc.). For example, a user or operator that is wearing the personnel identifier system 200 may actuate the switch 252 to turn on or turn off the lighting subsystem 220. For example, the lighting subsystem 220 and the switch 252 are mountable to the housing 250.

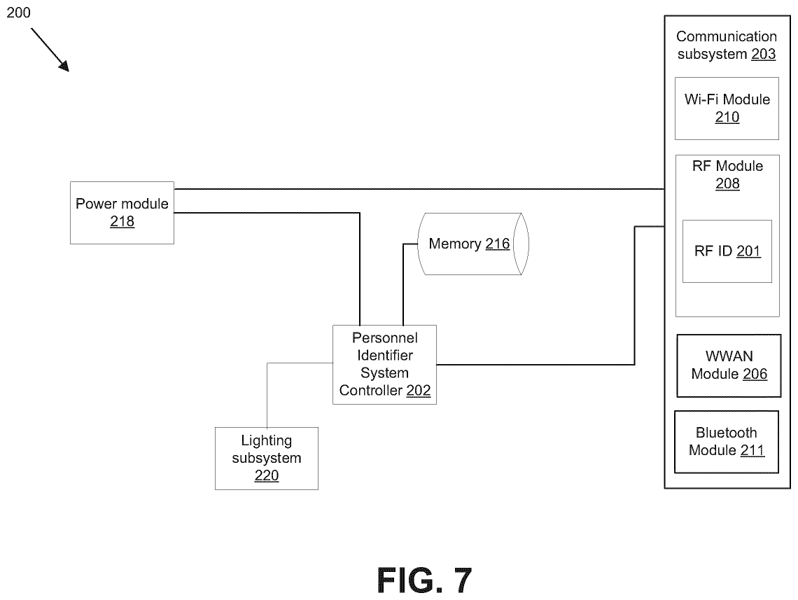

FIG. 7 depicts a block diagram of the personnel identifier system 200. As depicted, the personnel identifier system may include a personnel identifier system controller 202, a communication subsystem 203, a memory 216, a power module 218, and a lighting subsystem 220.

For example, the personnel identifier system controller 202, communication subsystem 203, memory 216, and power module 218 may be mounted to a circuit board, which is mounted to the housing of the personnel identifier system 200.

The personnel identifier system controller 202 may be connected with and controls the communication subsystem 203. The personnel identifier system 200 may include a unique identification, such as an alphanumeric 9 digit code or a MAC address of the personnel identifier system 200. For example, the personnel identifier system controller 202 may transmit data representative of the personnel identifier system 200, which For example, includes the identification of the personnel identifier system 200, to the vehicle system controller 160, periodically or real time.

The personnel identifier system 200 may have a user interface. For example, the personnel identifier system 200 embodied in a cap lamp may have one or more buttons. There may also be a display e.g. at the belt unit of the cap lamp, or a separate display. This may be useful if the operator wants to acknowledge the inspection phases to the vehicle system 100, e.g. by pressing buttons.

The RF ID 201 may contain an identifier uniquely associated with the personnel identifier system 200. When the personnel identifier system 200 is proximate to one or more of the detection subsystems 150 of the vehicle system 100, for example, within 1 meter, the identifier of the RF ID 201 may be read by the RF ID reader 104 of the vehicle system 100. The RF ID reader 104 may work on the same frequency as the RF ID. The RF ID reader 104 may send the identifier to the vehicle system controller 160. The vehicle system controller 160 may associate the personnel identifier system 200 with the identifier. For example, the RF ID 201 may be an NFC tag.

For example, the personnel identifier system 200 may include a personnel identifier system controller 202 that is in operable communication with a memory 216, for executing instructions stored in the memory 216 that, when executed, causes the personnel identifier system controller 202 to transmit data representative of the personnel identifier system 200. For example, the personnel identifier system controller 202 may be for executing instructions stored in the memory 216 that, when executed, causes the personnel identifier system controller 202 to wirelessly transmit data representative of the personnel identifier system 200 to the vehicle system 100. For example, the data representative of the personnel identifier system 200 may include data representative of the proximity or location of the personnel identifier system 200, or data representative of the identification of the personnel identifier system 200. For example, the personnel identifier system controller 202 may be transmitting data representative of the personnel identifier system 200 in response to a control command or enquiry from the vehicle system controller 160. The transmitting may be carried out by forming a message containing the data and transmitting the message over a radio connection. The transmitting may happen by such a transponder mechanism where the personnel identifier system 200 modulates the signal transmitted by the vehicle system 100.

For example, the personnel identifier system controller 202 may include a processor/a CPU, a memory such as RAM, and input/output peripherals. In some examples, the personnel identifier system controller 202 may receive commands from the vehicle system controller 160 of the vehicle system 100 via the communications subsystem 203. The personnel identifier system controller 202 may then implement the commands from the vehicle system controller 160.

For example, the personnel identifier system controller 202 may determine the proximity of the personnel identifier system 200 relative to the one or more detection subsystems 150 in the same manner as described herein with respect to the vehicle system controller 160.

For example, the memory 216 may be substantially similar to the memory 130. For example, the memory 216 is rewritable memory. For example, the memory 216 may include information representative of an identifier or identification of the personnel identifier system 200. For example, the identification is a code on an RFID chip, an NFC tag, a memory coupled to an interface, a label, and the like. For example, the personnel identifier system controller 202 may be configured to transmit said identification information to the vehicle system controller 160, such that the vehicle system controller 160 may receive the identification of the personnel identifier system 200.

For example, the memory 216 may store information representative of a unique identification of the personnel identifier system 200, and the personnel identifier system controller 202 may be configured to transmit data representative of the unique identification of the personnel identifier system 200. For example, the data transmitted by the personnel identifier system controller 202 may include transmitting data representative of the unique identification of the personnel identifier system 200. For example, the identification of the personnel identifier system 200 may include or may be a bit string or a data structure associable with the personnel identifier system 200, which may be associated with an operator's name, employee number, level of training and authorization, and the like.

For example, the personnel identifier system controller 202 may be configured to receive data representative of confirmation of validity of the unique identification of the personnel identifier system 200, for example, that is validated by the vehicle system controller 160 or by the server 300.

For example, the personnel identifier system controller 202 may be configured to detect a presence of a vehicle system 100, and, in response, transmit data representative of the personnel identifier system 200 to the vehicle system 100.

For example, the personnel identifier system controller 202 may be configured to receive a control command from the vehicle system controller 160, for example, via the communication subsystem 203. For example, the control command from the vehicle system controller 160 may be based on the detected or sensed proximity of the personnel identifier system 200 relative to the one or more detection subsystems 150. In response to the control command from the vehicle system controller 160, the personnel identifier system controller 202 may be configured to send a control command to the lighting subsystem 220 to variably activate the lighting subsystem 220, for example, to variable activate the variable lighting output of the lighting subsystem 220, or to have the lighting subsystem 220 illuminate a colour representative of the proximity of the personnel identifier system 200 relative to the one or more detection subsystems 150 as described herein with respect to the lighting subsystem 112, or to modulate the lighting subsystem 220 (e.g. blink, flash, etc.). For example, the personnel identifier system controller 202 may variably activate the corresponding light output of the lighting subsystem 220 of the personnel identifier system 200 to illuminate a green colour while the personnel identifier system 200 is outside the first threshold proximity of the respective detection subsystem 150, a yellow colour while the personnel identifier system 200 is within the first threshold proximity of the respective detection subsystem 150, and a red colour while the personnel identifier system 200 is within the second threshold proximity of the respective detection subsystem 150.

For example, the personnel identifier system controller 202 may determine the proximity of the personnel identifier system 200 relative to the one or more detection subsystems 150 in the same manner as described herein with respect to the vehicle system controller 160, and based on said determination, the personnel identifier system controller 202 may be configured to send a control command to the lighting subsystem 220 to variably activate the lighting subsystem 220.

The communication subsystem 203 may provide communication channels or communication modalities between the personnel identifier system controller 202 of the personnel identifier system 200 and the vehicle system controller 160 of the vehicle system 100. For example, the communication subsystem 203 may be a wireless communication subsystem. The communication subsystem 203, as depicted in FIG. 7, includes a Wi-Fi module 210, an RF module 208, a WWAN module 206, and a Bluetooth module 211. For example, the RF ID 201 is included in the RF module 208. The Wi-Fi module 210 may be similar to the Wi-Fi module 210. The RF module 208 may be similar to the RF module 108. The WWAN module 206 may be similar to the WWAN module 106. The Bluetooth module 211 may be similar to the Wi-Fi module 111. The configurations of the communication subsystem 203 may be similar to the communication subsystem 103 as described with respect to the vehicle system 100. The Wi-Fi module 210 may be used to communicate with the vehicle system 100, for example, for detecting the proximity of the personnel identifier system 200. The RF module 208 of the personnel identifier system 200 and the RF module 108 of the vehicle system 100 may be configured to establish a wireless channel at the frequency band, for example on the unlicensed frequency spectrum, such as 915 MHz. A personnel identifier system 200 and the vehicle system 100 may communicate with each other via the unlicensed frequency band or channel. For example, the personnel identifier system 200 and the vehicle system 100 communicate with each other via a short range communication protocol, such as a radio-frequency identification (RFID) protocol or a near field communication (NFC) protocol. In this regard, the vehicle system controller 160 may be configured to detect the proximity of the personnel identifier system 200 relative to the one or more detection subsystems 150.

The Wi-Fi module 210 of the personnel identifier system 200 and Wi-Fi module 110 of the vehicle system 100 may allow the personnel identifier system 200 to communicate with the vehicle system 100 via a Wi-Fi network. For example, the communication established between the Wi-Fi module 210 and Wi-Fi module 110 may allow for determining of the proximity of the personnel identifier system 200 using time of flight to the personnel identifier system 200, such as via triangulation between the personnel identifier system 200 and at least two of the wireless communication subsystems 103 from respective detection subsystems 150. For example, the Wi-Fi network may be used for the personnel identifier system controller 202 of the personnel identifier system 200 to transmit data from the memory 216 to the vehicle system controller 160 of the vehicle system 100, and may receive commands from the vehicle system controller 160 of vehicle system 100.

For example, communication between the vehicle system 100 and the personnel identifier system 200 may be via a short range communication protocol, such as RF ID, Bluetooth™, and Wi-Fi.

For example, the communication subsystem 203 may include an omnidirectional antenna or multi-array antenna for transmitting or receiving data and other information, for example, data representative of the proximity of the personnel identifier system 200 relative to a detection subsystem 150, identification of the personnel identifier system 200, and proximity warnings.

The power supply module 218 may supply power to the personnel identifier system, such as the personnel identifier system controller 202, the communication subsystem 203, and the lighting subsystem 220. For example, the power module 218 may include an RF coil that is externally energized.

For example, the power supply module 218 may be charged via wireless charging, or charged via electrical communication with a power source, for example, with a metal contact.

For example, the power module 218 may contain one or more disposable batteries, such as CR2032 or AAA batteries, or rechargeable batteries. The power supply module 218 may supply the power to the personnel identifier system 200 for at least a desired period, such as six months.

For example, where the personnel identifier system 200 may be integrated or partially integrated with mining personal protective equipment, such as a cap lamp, the personnel identifier system 200 may be charged in a charging rack for the mining personal protective equipment, and an operator may select a charged personnel identifier system 200 to be worn prior for entering the mine.

For example, the personnel identifier system 200 may report the remaining battery life to the vehicle system 100, server 300, or user equipment 400.

The lighting subsystem 220 of the personnel identifier system 200 may include a light output, for example a variable light output, for example, a cap lamp light and/or one or more RGB LEDs. For example, the lighting subsystem 220 is in operable communication with the personnel identifier system controller 202, such that a control command may be transmitted to the lighting subsystem 220 to activate, for example, variably activate, the light output of the lighting subsystem 220 and for the lighting subsystem 220 to illuminate a certain colour or animation. For example, the variable light output of the respective lighting subsystem 220 is activatable corresponding to proximity of the personnel identifier system 200 relative to the one or more detection subsystems 150. For example, the variable light output of the respective lighting subsystem 220 may be activatable corresponding to the diagnosing of different operating statuses of the respective detection subsystem 150.

For example, the lighting subsystem 220 may be similar to the lighting subsystem 112 of the vehicle system 100.

For example, the personnel identifier system 200 may include a user interface 254 for an operator to input a status, such as an operational status, of the one or more detection subsystems 150 or the vehicle 50 to the personnel identifier system 200. The personnel identifier system 200 may transmit the inputs from the user to the server 300 and/or the vehicle system controller 160. As depicted in FIG. 6, the user interface 254 includes a button that is on the cap lamp. For example, the user interface 254 may include a user display on the belt unit or cap lamp, or the display may be a separate display.

For example, the vehicle collision avoidance system 10 is configured to diagnose the operating status of one or more detection subsystems 150.

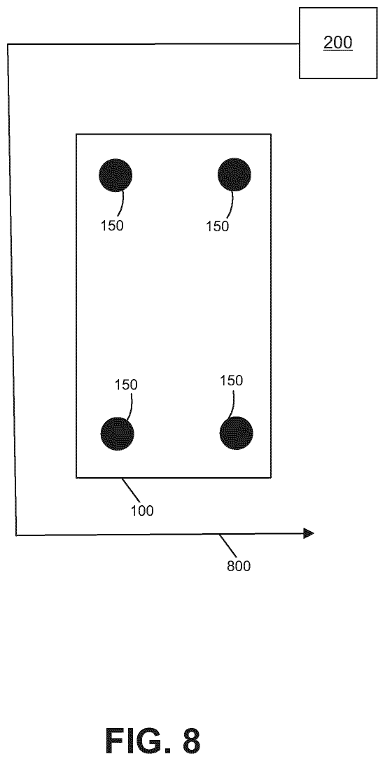

For example, the one or more detection subsystems 150, each of the one or more detection subsystems 150 including a respective wireless communication subsystem 103, are configured to determine a proximity of the personnel identifier system 200 and receive the identification of the personnel identifier system 200 from the personnel identifier system 200, for example, while the personnel identifier system 200 is proximate the vehicle system 100 during a pre-operation inspection, as depicted in FIG. 8. As the personnel identifier system 200 may displace around the vehicle system 100, the one or more detection subsystems 150 determines that the personnel identifier system 200 is proximate the respective one or more detection subsystems 150. Based on the determination of the proximity of the personnel identifier system 200 relative to the one or more detection subsystems 150 and the identification of the personnel identifier system 200, the vehicle system controller 160 is configured to diagnose an operating status of each of the one or more detection subsystems 150. For example, the vehicle system controller 160 may determine that communication between the personnel identifier system 200 and the one or more detection subsystems 150 is established, and in response, may diagnose the operating status of each of the one or more detection subsystems 150 as approved.

For example, the vehicle system controller 160 may be configured to determine that, based on the identification of the personnel identifier system 200, said personnel identifier system 200 may be authorized for diagnosing the one or more detection subsystems 150 may be proximate the one or more detection subsystems 150, and in response, may diagnose the operating status of each of the one or more detection subsystems 150 as approved.

The diagnosis of the operating status of each of the one or more detection subsystems 150 may be also based on the identification of the personnel identifier system 200. For example, the vehicle system controller 160 checks that the identification of the personnel identifier system 200 is representative of an appropriate personnel identifier system 200 or expected personnel identifier system 200. Accordingly, the vehicle system controller 160 may not diagnose the operating status of each of the one or more detection subsystems 150 based on another personnel identifier system 200, for example, one that is worn on a person walking by the vehicle system 100, rather than the personnel identifier system 200 worn by an inspector or operator of the vehicle system 100.

For example, the determination of the proximity of the personnel identifier system 200 relative to the one or more detection subsystems 150 may be individually performed on each of the detection subsystems 150. For example, the vehicle system controller 160 may determine that communication between the personnel identifier system 200 and each of the one or more detection subsystems 150 is established, and in response, diagnoses the operating status of each of the one or more detection subsystems 150 as approved.

For example, the vehicle system controller 160 may be configured to determine, based on the data representative of the proximity of the personnel identifier system 200, that the proximity of the personnel identifier system 200 relative to the respective detection subsystem 150 is within a first threshold proximity, for example 5 or 10 meters, and wherein the diagnosing the operating status of the respective detection subsystem 150 is based on the determination that the personnel identifier system 200 is within the first threshold proximity of the respective detection subsystem 150. For example, the vehicle system controller 160 may determine that the one or more detection subsystems 150 has detected or sensed that the personnel identifier system 200 is within the first threshold proximity, and in response, based on said determination, may diagnose the operating status of each of the one or more detection subsystems 150 as approved for operation.

For example, the vehicle system controller 160 may be configured to determine, based on the data representative of the proximity of the personnel identifier system 200, that the proximity of the personnel identifier system 200 relative to the respective detection subsystem 150 is within a second threshold proximity that is less than the first threshold proximity, for example 2 or 5 meters, and wherein the diagnosing the operating status of the respective detection subsystem 150 is based on the determination that the personnel identifier system 200 is within the second threshold proximity of the respective detection subsystem 150. For example, the vehicle system controller 160 may determine that the one or more detection subsystems 150 has detected or sensed that the personnel identifier system 200 is within the second threshold proximity, and in response, based on said determination, may diagnose the operating status of each of the one or more detection subsystems 150 as approved for operation.

For example, the operating status of the one or more detection subsystems 150 may be determined to be approved for operation when the vehicle system controller 160 may determine that each of the one or more detection subsystems 150 is able to detect that the personnel identifier system 200 is at various proximities relative to the respective one or more detection subsystems 150. For example, the one or more detection subsystems 150 may detect that the personnel identifier system 200 is outside a first threshold proximity (e.g. outside 5 or 10 meters), within a first threshold proximity (e.g. within 5 or 10 meters), within a second threshold proximity that is less than the first threshold proximity (e.g. 2 or 5 meters), and/or within a threshold inspection proximity (e.g. 1 or 2 meters), of the respective one or more detection subsystems 150, and based on said detections, the vehicle system controller 160 may determine that each of the one or more detection subsystems 150 is able to detect the personnel identifier subsystem 200 at various proximities relative to the respective one or more detection subsystems 150 such that the one or more detection subsystems 150 may be approved for operation. For example, the vehicle system controller 160 may diagnose a detection subsystem 150 to be operational if the detection subsystem 150 detects that the personnel identifier system 200 is moving closer to the detection subsystem 150, from outside the first threshold proximity to within the threshold inspection proximity.

For example, based on the detection of the personnel identifier system 200 by the one or more detection subsystems 150 at various proximities relative to the one or more detection subsystems 150, the vehicle system controller 160 may be configured to determine the operator wearing the personnel identifier system 200 to be at said various proximities relative to the one or more detection subsystems 150.

For example, when the diagnosing of the operating status of the respective detection subsystem 150 is approved for operation, the vehicle system controller 160 may be configured to activate a light output of the lighting subsystem 112. For example, each lighting subsystem 112 may comprise a variable light output, the variable light output of the respective lighting subsystem 112 being activatable corresponding to the diagnosing of different operating statuses of the respective detection subsystem 150. For example, when the respective detection subsystem 150 is diagnosed as approved for operation, the vehicle system controller 160 may send a control command to the respective lighting system 112 to illuminate a colour representative of an approved operating status of the respective detection subsystem 150, such as a blue colour. For example, when the respective detection subsystem 150 is diagnosed as not approved for operation, the vehicle system controller 160 may send a control command to the respective lighting system 112 to illuminate a colour representative of a non-approved operating status of the respective detection subsystem 150, such as an orange colour.

For example, when the personnel identifier system 200 may be within a first threshold proximity of the respective detection subsystem 150, the vehicle system controller 160 may be configured to variably activate the corresponding light output of the respective lighting subsystem 112 of the respective detection subsystem 150 to a first light output.

For example, the vehicle system controller 160 may be configured to determine, based on the proximity of the personnel identifier system 200, that the proximity of the personnel identifier system 200 relative to the respective detection subsystem is within a first threshold proximity. Based on the determination that the personnel identifier system 200 is within the first threshold proximity of the respective detection subsystem 150 and the data representative of the identification of the personnel identifier system 200, the vehicle system controller 160 may be configured to diagnose the operating status of each of the respective or more detection subsystems 150. In addition, based on the determination that the personnel identifier system 200 is within the first threshold proximity of the respective detection subsystem 150, the vehicle system controller 160 may be configured to variably activate the corresponding light output of the respective lighting subsystem 112 to a first light output, for example, to a yellow colour. For example, the vehicle system controller 160 may determine that the one or more detection subsystems 150 has detected or sensed that the personnel identifier system 200 is within the first threshold proximity and that the lighting subsystem 112 is illuminating the colour representative of the personnel identifier system 200 being within the first threshold proximity of the one or more detection subsystems 150, and in response, may diagnose the operating status of each of the one or more detection subsystems 150 as approved.

For example, when the personnel identifier system 200 is within a second threshold proximity, which is less than the first threshold proximity, of the respective detection subsystem 150, the vehicle system controller 160 may be configured to variably activate the corresponding light output of the respective lighting subsystem 112 of the respective detection subsystem 150 to a second light output that is different from the first light output.

For example, the vehicle system controller 160 may be configured to determine, based on the proximity of the personnel identifier system 200, that the proximity of the personnel identifier system 200 relative to the respective detection subsystem is within a second threshold proximity that is less than the first threshold proximity. Based on the determination that the personnel identifier system 200 is within the second threshold proximity of the respective detection subsystem 150 and the data representative of the identification of the personnel identifier system 200, the vehicle system controller 160 may be configured to diagnose the operating status of each of the respective or more detection subsystems 150. In addition, based on the determination that the personnel identifier system 200 is within the second threshold proximity of the respective detection subsystem 150, the vehicle system controller 160 may be configured to variably activate the corresponding light output of the respective lighting subsystem 112 to a second light output, for example, to a red colour. For example, the vehicle system controller 160 may determine that the one or more detection subsystems 150 has detected or sensed that the personnel identifier system 200 is within the second threshold proximity and that the lighting subsystem 112 is illuminating the colour representative of the personnel identifier system 200 being within the second threshold proximity of the one or more detection subsystems 150, and in response, may diagnose the operating status of each of the one or more detection subsystems 150 as approved.

For example, when the personnel identifier system 200 is outside the first threshold proximity of the respective detection subsystem 150, the vehicle system controller 160 may be configured to variably activate the corresponding light output of the respective lighting subsystem 112 of the respective detection subsystem 150 to a light output that is different from the first light output, for example, a third light output that is different from the first and second light outputs.

For example, the vehicle system controller 160 may be configured to determine, based on the data representative of the proximity of the personnel identifier system 200, that the proximity of the personnel identifier system 200 relative to the respective detection subsystem 150 is outside the first threshold proximity, and based on the determination that the personnel identifier system 200 is outside the first threshold proximity of the respective detection subsystem 150, variably activate the corresponding light output of the respective lighting subsystem 112 to a third colour light output that is different from the first and the second light output, such as a green colour. For example, the vehicle system controller 160 may determine that the one or more detection subsystems 150 has detected or sensed that the personnel identifier system 200 is outside the first threshold proximity and that the lighting subsystem 112 is illuminating the colour representative of the personnel identifier system 200 being outside the first threshold proximity of the one or more detection subsystems 150, and in response, may diagnose the operating status of each of the one or more detection subsystems 150 as approved.

For example, the light output of the respective lighting subsystems 112 may be visible from the cabin 52 of the vehicle 50. The lighting subsystem 112 of the detection subsystem 150 may be variably activated while the personnel identifier system 200 is proximate the corresponding detection subsystems 150, which may indicate to an operator in the cabin 52 of the vehicle 50 the direction of the personnel identifier system 200 relative to the vehicle 50, based on which of the one or more detection subsystems 150 is illuminated.

For example, the vehicle system controller 160 may be configured to determine, that the proximity of the personnel identifier system 200 relative to the respective detection subsystem 150 is outside, for example, only outside, a first threshold proximity, and based on the determination that the personnel identifier system 200 is outside, for example, only outside, the first threshold proximity of the respective detection subsystem 150, the diagnosing of the operating status may indicate a non-approved operating status.

As an operator with the personnel identifier system 200 moves relative to the one or more detection subsystems 150, the operator may observe the status of the one or more detection subsystems 150. The operator may observe that the one or more detection subsystems 150 is approved or not approved for operation. For example, the operator may observe that the lighting subsystem 112 is variably activated, for example, to illuminate the green, yellow, or red colour, corresponding to the proximity of the personnel identifier system 200 relative to the one or more detection subsystems 150, such that the one or more detection subsystems 150 may be approved for operation. The operator may provide an input via the user interface 254, for example, by pressing a button, to the system 10, for example, to the server 300 and/or the vehicle system controller 160, to indicate that the one or more detection subsystems 150: 1) may be able to detect the personnel identifier system 200, 2) may be able to detect the personnel identifier system 200 outside of the first threshold proximity or within the first, second, or inspection threshold proximities, such that the one or more detection subsystems 150 may be approved for operation.

For example, the vehicle system controller 160 and/or server 300 may use the input via the user interface 254 based on the operator's observations of the status of the one or more detection subsystems 150 and compare said input with the diagnosis of the status of each of the one or more detection subsystems 150 by the vehicle system controller 160. If the input based on the observation from the operator and the diagnosis by the vehicle system controller 160 with respect to the status of the one or more detection subsystems 150 are consistent, the vehicle system controller 160 and or server 300 may confirm that the diagnosing of the status of the one or more detection subsystems 150 by the vehicle system controller 160 may be accurate.

For example, the diagnosing of the operating status of each of the one or more detection subsystems 150 may be approved for operation based on a detection sequence amongst the detection subsystems 150.

For example, the one or more detection subsystems 150 may be positioned to detect peripherally about the vehicle system, wherein the detection sequence includes the detection subsystems detecting the proximity of the personnel identifier system in peripherally adjacent sequential order.

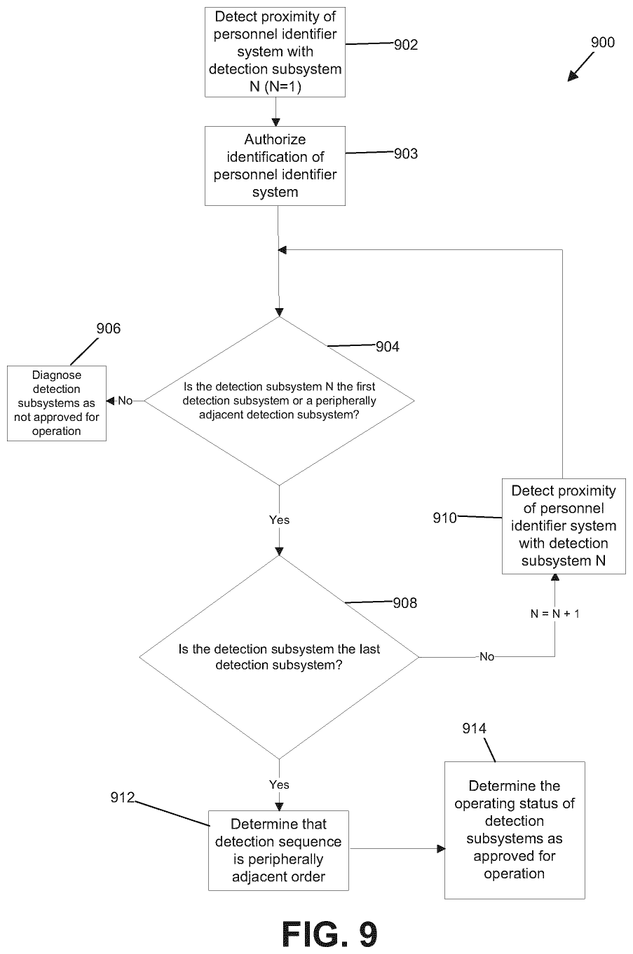

FIG. 9 is a flow chart depicting a method 900 of diagnosing the one or more detection subsystems 150 based on the identification of the personnel identifier system 200 and the detection sequence amongst the detection subsystems 150.

At 902, the personnel identifier system 200 may be detected by the first detection subsystem 150 to be proximate to the first detection subsystem 150. For example, any of the one or more detection subsystems 150 may be the first detection subsystem 150. For example, as depicted in FIG. 8, the first detection subsystem 150 may be the detection subsystem 150 is disposed and is configured to detect front right of the vehicle system 100.

At 903, the vehicle system controller 160 and/or the server 300 may authorize the identification of the personnel identifier system 200. The vehicle system controller 160 and/or the server 300 may be configured to determine an identification of an authorized operator of the vehicle system 100, and compare the identification of the authorized operator of the vehicle system 100 with the identification of the personnel identifier system 200. For example, the identification of an authorized operator may be transmitted to the vehicle system controller 160 by the server 300. For example, the identification of an authorized operator may be retrieved from memory 130 by the vehicle system controller 160, for example, based on the identification of one or more previously authorized operators of the vehicle system 100. When the identification of the personnel identifier system 200 matches the identification of an authorized operator, the vehicle system controller 160 and/or the server 300 may authorize the identification of the personnel identifier system 200.

For example, the personnel identifier system 200 of the operator that switches on the vehicle 50 may become authorized to perform the inspection and becomes associated with the inspection by the vehicle system controller 160 or by the server 300.

For example, the personnel identifier system 200 may transmit an authorization token to the vehicle system controller 160 and/or server 300, and the vehicle system controller 160 and/or server 300 authorizes the personnel identifier system 200 for inspection of the vehicle system 100 and/or the vehicle 50 based on said authorization token.

At 904, the vehicle system controller 160 may determine if the detection subsystem 150 that is detecting the proximity of the personnel identifier system 200 is the first detection subsystem 150 or a peripherally adjacent subsystem. If not, then at 906, the vehicle system controller 160 may diagnose that the detection subsystems 150 as not approved for operation.

If yes, then at 908, the vehicle system controller 160 may determine if the detection subsystem 150 that is detecting the proximity of the personnel identifier system 200 is the last detection subsystem 150 of the vehicle system 100. If no, another detection subsystem 150 may detect the proximity of the personnel identifier system 200 at 910. For example, as depicted in FIG. 8, the detection subsystem 150 disposed front left of the vehicle system 100 may detect the proximity of the personnel identifier system 200.

The vehicle system controller 160 again may determine if the detection subsystem 150 that is detecting the proximity of the personnel identifier system 200 is the first detection subsystem 150 or a peripherally adjacent subsystem at 904, and if yes, if the detection subsystem 150 that is detecting the proximity of the personnel identifier system 200 is the last detection subsystem 150 of the vehicle system 100 at 908.

If the detection subsystem 150 is the last detection subsystem 150 of the vehicle system 100, for example, the detection subsystem 150 disposed bottom left of the vehicle system 100 as depicted in FIG. 8, then at 912, the vehicle system controller 160 may determine that the detection sequence of the personnel identifier system 200 by the one or more detection subsystems 150 is in peripherally adjacent sequential order.

At 914, For example, based on the determination that the identification of the personnel identifier system 200 is authorized, and based on the determination that the detection sequence of the personnel identifier system 200 by the one or more detection subsystems 150 is in peripherally adjacent sequential order, the vehicle system controller 160 may diagnose those aspects of the one or more detection subsystems 150 as being approved for operation. For example, only those aspects may be required for final approval of the diagnosis of the one or more detection subsystems 150. For example, final approval can be dependent on additional factors.

For example, the one or more detection subsystems 150 may be inspected in a non-sequential order, and the vehicle system controller 160 may diagnose the status of the one or more detection subsystems 150 without inspection of the one or more detection subsystems 150 in a sequential order.

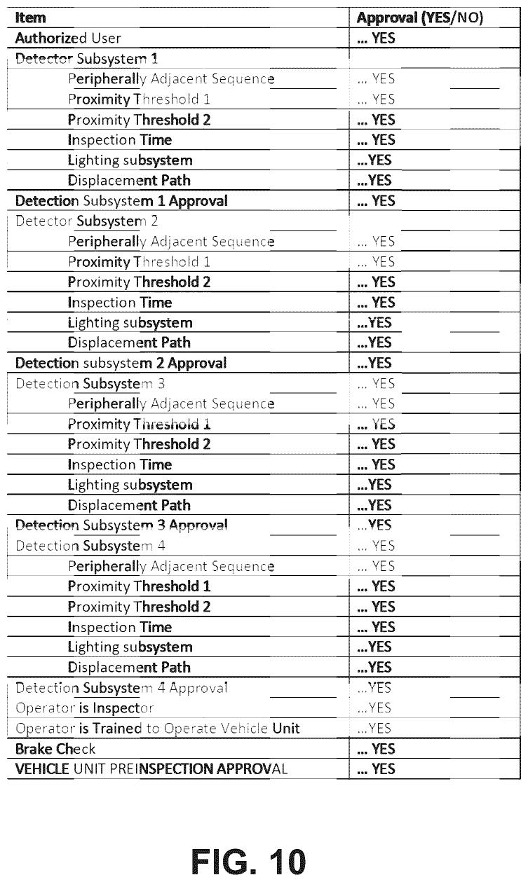

For example, the determination that the identification of the personnel identifier system 200 is authorized, and the determination that the detection sequence of the personnel identifier system 200 by the one or more detection subsystems 150 is in peripherally adjacent sequential order, may be part of a set of checks to be conducted by the vehicle system controller 160, for example, such as the criteria tabulated in FIG. 10, for diagnosing the one or more detection subsystems 150.

For example, the detection subsystems detecting the proximity of the personnel identifier system 150 in peripherally adjacent sequential order may represent the personnel identifier system 150 displaced around the vehicle system 100.

For example, the detection sequence may be determined based on the proximity of the personnel identifier system 200 being within: 1) the first proximity of the one or more detection subsystems 150, and 2) the second proximity of the one or more detection subsystems 150. For example, the personnel identifier system 200 may be disposed within the second proximity of the one or more detection subsystems 150 in order for the vehicle system controller 160 to determine that the personnel identifier system 200 is being detected in a sequence.

For example, the vehicle system controller 160 may be configured to determine an amount of time that the personnel identifier system 200 is proximate the respective detection subsystem, for example, by receiving data from a clock of the respective detection subsystem 150 representative of an amount of time that the personnel identifier system 200 is proximate the respective detection subsystem 150, for example, as the personnel identifier system 200 is displaced relative to the vehicle system 100, as depicted in FIG. 8. For example, the diagnosing the operating status of the respective detection subsystem 150 may be based on the amount of time exceeding an inspection time threshold. for example, the vehicle system controller 160 may determine that the one or more detection subsystems 150 has detected or sensed that the personnel identifier system 200 is proximate to the one or more detection subsystems 150 for at least the inspection time threshold, and in response, based on said determination, diagnoses the operating status of each of the one or more detection subsystems 150 as approved for operation.

For example, the vehicle system controller 160 may be configured to determine an amount of time that the personnel identifier system 200 is at a predetermined distance from the respective detection subsystem 150, wherein the diagnosing the operating status of the respective detection subsystem 150 is approved for operation based on the amount of time exceeding an inspection time threshold. For example, the vehicle system controller 160 may be configured to determine an amount of time that the personnel identifier system 200 is within the predetermined distance from the respective detection subsystem, wherein the diagnosing the operating status of the respective detection subsystem 150 is approved for operation based on the amount of time exceeding an inspection time threshold. For example, the vehicle system controller 160 may be configured to determine an amount of time that the personnel identifier system 200 is within at a direction relative to the respective detection subsystem 150, wherein the diagnosing the operating status of the respective detection subsystem 150 is approved for operation based on the amount of time exceeding an inspection time threshold.

For example, the vehicle system controller 160 may be configured to determine, based on the proximity of the personnel identifier system 200 to the one or more detection subsystems 150, a displacement path 800 of the personnel identifier system 200 relative to the vehicle system 100, as depicted in FIG. 8. For example, the vehicle system controller 160 may be configured to, based on the displacement path 800 of the personnel identifier system 200 relative to the vehicle system 100, evaluate an inspection time of the vehicle system 100, for example, for the diagnosing of the one or more detection subsystems 150. For example, the vehicle system controller 160 may be configured to perform the diagnosis of the operating status of the one or more detection subsystems 150 based on the displacement path 800.

For example, to determine the displacement of the personnel identifier system 200, the vehicle system controller 160 may be configured to: 1) receive, from the one or more detection subsystems 150, data representative of a first proximity of the personnel identifier system 200, 2) determine, based on the data representative of the first proximity of the personnel identifier system 200, a first position of the personnel identifier system 200 relative to the vehicle system 100, and 3) receive, from the one or more detection subsystems 150, data representative of a second proximity of the personnel identifier system 200, and 4) determine, based on the data representative of the second proximity of the personnel identifier system 200, a second position of the personnel identifier system 200 relative to the vehicle system 100. Based on: 1) the first position of the personnel identifier system 200 relative to the vehicle system 100, and 2) the second position of the personnel identifier system 200 relative to the vehicle system 100, the vehicle system controller 160 may be configured to determine a displacement of the personnel identifier system 200 relative to the vehicle system 100.

For example, the vehicle system controller 160 may be configured to determine that the operating status of said system 10 is approved for operation, and enable engine start-up in response to determination that the operating status of said system 10 is approved for operation.

For example, for at least one or more detection subsystems 150, the vehicle system controller 160 may be configured to determine that no communication is established between the personnel identifier system 200 and the respective detection subsystem 150, and in response, the diagnosing of the operating status indicates a non-approved operating status of the respective detection subsystem 150.

For example, the vehicle system controller 160 may be configured to receive data representative of a successful brake test of the vehicle 50, for example, from the brake subsystem of the vehicle subsystems 170, and based on the receiving the data representative of the successful brake test and when the operating status of said system is approved for operation, enable engine start-up, for example, by sending a control command to the engine subsystem of the vehicle subsystems 170.

For example, the vehicle system controller 160 may be configured to determine whether the vehicle system 100 moves when applying gas against the brakes, and based on said determination, determine whether the brake test was successful.

For example, the vehicle system controller 160 may be configured to initiate the brake test, for example, by sending a control command to the brake subsystem of the vehicle subsystems 170, in response to the determination that the operating status of each of the one or more detection subsystems 150 is approved for operation.

For example, the vehicle system controller 160 may be configured to, prior to receiving the data representative of the successful brake test, bind a brake subsystem of the vehicle system 100, for example, by sending a control command to the brake subsystem of the vehicle subsystems 170. For example, the vehicle system controller 160 may be configured to, in response to receiving data representative of the successful brake test, unbind the brake subsystem of the vehicle system 100, for example, by sending a control command to the brake subsystem of the vehicle subsystems 170.

For example, the vehicle system controller 160 may be configured to determine an identification of an authorized operator of the vehicle system 100, for example, via input of said identification by the authorized operation using the user interface 1600, or via data sent to the vehicle system controller 160 from the server 300. The vehicle system controller 160 may be configured to compare the data representative of the identification of the operator of the vehicle system 100 with the data representative of the identification of the personnel identifier system 200, and based on the comparison, validate the operator. In response to successful validation from the validating of the operator, the vehicle system controller 160 may be configured to enable, when identification of the personnel identifier system 200 matches the authorized operator and when the diagnosing the operating status of the one or more detection subsystems 150 is approved for operation, start-up of the vehicle system 100, for example, by sending a control command to the vehicle subsystems 170.

For example, the vehicle system controller 160 may be configured to receive data representative of authorization of the user to operate the vehicle system 100, for example, via input from the user interface 1600 or the server 300, or to retrieve said data from the memory 130, and validate, based on the data representative of authorization of the user to operate the vehicle system 100, authority of the user to operate the vehicle system 100, for example, that the user is trained to operate the vehicle system 100. In response to successful validation from the validating and the diagnosing of the operating status of the respective detection subsystem being approved for operation, the vehicle system controller 160 may be configured to enable start-up of the vehicle system 100, for example, by sending a control command to the vehicle subsystems 170.

For example, after the operating status of the one or more detection subsystems 150 is approved for operation, start-up of the vehicle 50 may be enabled by the vehicle system controller 160. Then, in response to receiving data representative of a successful brake test of the vehicle 50, start-up and/or usage of the vehicle 50 may be enabled by the vehicle system controller 160.

For example, where an operator is not authorized to operate the vehicle system 100, an emergency bypass may be input, for example, via the user interface 1600 to enable operation of the vehicle system 100. If bypassing of the inspection of the vehicle system 100 is needed, for example, an emergency situation such as a fire, an emergency bypass may be input, for example, via the user interface 1600 to enable operation of the vehicle 50.

For example, an inspector with a user equipment 400 may visually inspect the vehicle 50. The server 300 or vehicle system controller 160 may send a control command to the user equipment 400 to display a visual inspection checklist on the user equipment 400, and the inspector inspects the vehicle 50 based on the visual inspection checklist. For example, the mining vehicle collision avoidance system 10 may be configured to evaluate a visual inspection of the vehicle 50.

For example, the vehicle system controller 160 may be configured to determine an amount of time that the personnel identifier system 200 is proximate the respective detection subsystem 150. Based on the data representative of an amount of time that the personnel identifier system 200 is proximate the detection subsystem 150, the vehicle system controller 160 may be configured to evaluate a visual inspection of the vehicle 50.

For example, the vehicle system controller 160 may be configured to determine, based on the data representative of an amount of time that the personnel identifier system 200 is proximate the detection subsystem 150, that the personnel identifier system 200 is proximate to the detection subsystem 150 for at least an inspection time threshold, and based on the determination that the personnel identifier system 200 is proximate to the detection subsystem 150 for at least the inspection time threshold, evaluate the visual inspection of the vehicle 50. For example, the inspection time threshold is representative of an amount of time that is required to visually inspect the vehicle 50, or the portion of the vehicle 50 on which the respective detection subsystem 150 is disposed. Based on the determination that the personnel identifier system 200 is proximate to the detection subsystem 150 for at least the inspection time threshold, the vehicle system controller 160 may be configured to have approved the visual inspection of the vehicle 50 and this approval may be stored in the system 10 for the portion of the vehicle 50 on which the respective detection subsystem 150 is disposed and the components of the vehicle 50 that are disposed in said portion of the vehicle 50.

For example, the vehicle system controller 160 may be configured to evaluate the visual inspection of a certain component of the mining vehicle 50, based on data representative of an association of one or more detection subsystems 150 with a component of the mining vehicle 50. For example, based on the determination that the personnel identifier system 200 is proximate to the detection system 150 that is installed on the front left portion of the vehicle 50 for at least the inspection time threshold, the vehicle system controller 160 may be configured to determine, based on the data representative of an association of one or more detection subsystems 150 with a component of the mining vehicle 50 (e.g. the detection subsystem 150 installed on the front left portion of the vehicle is proximate the front left tire), that the front left tire of the vehicle 50 has been visually inspected. For example, the inspection time threshold for the one or more detection subsystems 150 may vary, for example, if more time is required to inspect a particular portion of the vehicle 50 or particular components of the vehicle 50 that are disposed proximate a particular detection subsystem 150 (e.g. it may take more time to determine that the tires of the vehicle 50 are at the desired pressure than to check that the headlights of the vehicle 50 are operational).

For example, based on the determination that the personnel identifier system 200 is proximate to the detection subsystem 150, for example, at a certain position relative to the vehicle 50 where visual inspection should be made, for less than the inspection time threshold, the vehicle system controller 160 may be configured to disapprove the visual inspection of the vehicle 50.

For example, the one or more detection subsystems 150 may be configured to have a respective inspection time threshold, representative of different portions of the vehicle 50 requiring different amounts of time for inspection.

For example, the vehicle system controller 160 may be configured to, based on the displacement path 800 of the personnel identifier system 200 relative to the vehicle 50, evaluate a visual inspection of the vehicle 50. For example, where the displacement path 800 of the personnel identifier system 200 is representative of displacement around the vehicle 50 as depicted in FIG. 8, the vehicle system controller 160 may be configured to approve the visual inspection of the vehicle 50. For example, where the displacement path 800 of the personnel identifier system 200 is not representative of displacement around the vehicle 50, the vehicle system controller 160 may be configured to disapprove the visual inspection of the vehicle 50.

FIG. 10 is a table depicting processing criteria that may be considered for diagnosing the one or more detection subsystems 150. FIG. 10 depicts the vehicle system 100 having four detection subsystems 150. For example, the vehicle system 100 has one or more detection subsystems 150.

For example, the vehicle system controller 160 may be configured to check each of the criteria tabulated in FIG. 10 in order to diagnose that the one or more detection subsystems 150 is approved for operation. For example, if the vehicle system controller 160 may determine that one or more of the criteria is not satisfied, the vehicle system controller 160 may diagnose that the one or more detection subsystems 150 is not approved for operation.

The table of FIG. 10 represents a checklist that is performed by the vehicle system controller 160. For example, more or less items of the checklist may be used by the vehicle system controller 160 to assess the approval of the diagnosing of the one or more detection subsystems 150.

For example, the vehicle system controller 160 may be configured to send a control command to the user interface 1600 to display the table of FIG. 10 on the user interface 1600, and update the user interface 1600 as the criteria are satisfied or not satisfied, and as the operating status of the one or more detection subsystems 150 is diagnosed, with a “YES” or not satisfied with a “NO”.

For example, once the vehicle system controller 160 has diagnosed that each of the one or more detection subsystems 150 is approved for operation, the vehicle system controller 160 may be configured to send a control command to the vehicle subsystems 170 to enable engine start-up.

For example, the detected or sensed data by the detection subsystem 150, and the diagnoses and evaluations of the operating status of the one or more detection subsystems 150 and the visual inspections that are made by the vehicle system controller 160 may be saved to the memory 130. For example, the completion of the pre-operation check of the vehicle system 100, for example, for the detection subsystem 150, may be saved to the memory 130. For example, the detected or sensed data by the detection subsystem 150, and the diagnoses and evaluations of the operating status of the one or more detection subsystems 150 and the visual inspections that are made by the vehicle system controller 160 may be transmitted to the server 300 to be saved to memory. For example, the completion of the pre-operation check of the vehicle system 100, for example, for the detection subsystem 150, may be transmitted to the server 300 and saved to memory. For example, the path of the personnel identifier system 200 around the vehicle 50 and in respect of the detection sub-systems 150 may be saved, as well.

For example, the data detected or sensed by the detector subsystem 150, for example during the pre-operational check of the vehicle system 100, may be saved on the memory 130, or transmitted to the server 300 to be saved to memory.

For example, a reason for downtime in response to a negative diagnosis of the detection subsystem 150 or negative evaluation of the visual inspection may be saved to the memory 130, or may be transmitted to the server 300 to be saved to memory.

For example, the transmissions between the vehicle system 100 and the personnel identifier system 200 may be saved to memory 130, or may be transmitted to the server 300 to be saved to memory.

For example, the diagnosis of the one or more detection subsystems 150 or the inspection of the vehicle system 100 may be set to the beginning of a work shift. For example, a timer may determine the beginning of a work shift, or the server 300 may provide data corresponding to the beginning of a work shift.

For example, during the visual inspection, the user may input information to the user equipment 400. For example, the vehicle system controller 160 or server 300 may associate said information input via the user equipment 400 with the displacement path or position of the personnel identifier system 200.

For example, the system 10 may be configured to be checked for integrity and operation. For example, the system 10 is configured for the inspection of the system 10, the visual inspection of the vehicle 50, and detection of the personnel identifier system 200 at the same time.

A mining setting may have enclosed spaces, numerous objects, and high traffic of personnel and vehicles. For example, the system 10 allows for inspection without a clear environment, for example, without having a threshold distance from the vehicle system 100 to an adjacent wall or other objects. For example, objects that may be present in the inspection zone may not disturb the diagnosis of the detection subsystems 150. The system 10 may lead to improved reliability of the diagnosis of the operational status of the system 10 and each detection subsystem 150, thereby increasing the robustness of the system 10 and reducing risk of a safety hazard.

For example, the system 10 may be configured to operate with a brake check to enable or disable start-up of the engine.

For example, the system 10 may provide assurance to an operator that each of the detection subsystems 150 may detect a pedestrian, vehicle, or an object around the vehicle system 100 and that the mining vehicle 50 is safe to operate.

For example, the system 10 is configured to track that the system 10 integrity is checked prior to operation of the mining vehicle 50.

For example, the system 10 is configured to provide a detailed trace and a log of interaction of an operator and one or more detection subsystems 150 while the operator is walking around the mining vehicle 50, and that the one or more detection subsystems 150 detected the operator within or outside of one or more defined proximity thresholds.

For example, while doing the walk around of the mining vehicle 50 to do the pre-operation system inspection, the operator can also perform the daily machine walk around inspection and complete their pre-operation check list for the whole equipment.

For example, the tracking of the operator doing the pre-operation check by the system 10 may allow for the system 10 to auto-detect the person who may potentially operate the mining vehicle 50. Once the operator climbs into the mining vehicle 50, the system 10 may ask the operator to confirm: (i) their identity by providing identification data via the user interface 1600, (ii) that the operator is task trained to operate the mining vehicle 50, and (iii) report any items that failed during inspection of the mining vehicle 50 and/or the system 10.

Through the present description, the examples given may be implemented by using hardware only or by using software and a necessary universal hardware platform. Based on such understandings, the technical solution of some examples may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the example embodiments. For example, such an execution may correspond to a simulation of the logical operations as described herein. The software product may additionally or alternatively include number of instructions that enable a computer device to execute operations for configuring or programming a digital logic apparatus in accordance with the present description.

Example apparatuses and methods described herein, can be implemented by one or more controllers. The controllers can comprise hardware, software, or a combination of hardware and software, depending on the particular application, component or function. In some example embodiments, the one or more controllers can include analog or digital components, and can include one or more processors, one or more non-transitory storage mediums such as memory storing instructions executable by the one or more processors, one or more transceivers (or separate transmitters and receivers), one or more signal processors (analog and/or digital), and/or one or more analog circuit components.

In the described methods or block diagrams, the boxes may represent events, steps, functions, processes, modules, messages, and/or state-based operations, etc. Although some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined, and some of the messages or steps described above may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

The above discussed examples are considered to be illustrative and not restrictive. Examples described as methods would similarly apply to systems, and vice-versa.

Variations may be made to some example embodiments, which may include combinations and sub-combinations of any of the above. The example embodiments presented above are merely examples and are in no way meant to limit the scope of this disclosure. Variations of the innovations described herein will be apparent to persons of ordinary skill in the art, such variations being within the intended scope of the present disclosure. In particular, features and steps may be selected to create a sub-combination of features which may not be explicitly described above. In addition, features may be selected and combined to a combination of features which may not be explicitly described above. Features suitable for such combinations and sub-combinations would be readily apparent to persons skilled in the art upon review of the present disclosure as a whole. For example, two features or steps can appear together unless there is a clear technical reason why they could not. The subject matter described herein intends to cover and embrace all suitable changes in technology.

The specification and drawings are, accordingly, to be regarded simply as an illustration, and are contemplated to cover any and all modifications, variations, combinations or equivalents. Certain adaptations and modifications of the described embodiments can be made. Therefore, the above discussed embodiments are considered to be illustrative and not restrictive.

1. A mining vehicle collision avoidance system for avoiding collision with a personnel identifier system that is wearable, the personnel identifier system configured to transmit an identification of the personnel identifier system, the collision avoidance system comprising:
a vehicle system, comprising:
one or more detection subsystems, the one or more detection subsystems including a respective wireless communication subsystem configured to determine a proximity of the personnel identifier system and receive the identification of the personnel identifier system from the personnel identifier system;
a memory; and
a controller for executing instructions stored in the memory that, when executed, causes the controller to:
based on the determination of the proximity of the personnel identifier system relative to the one or more detection subsystems and the identification of the personnel identifier system, diagnose an operating status of each of the one or more detection subsystems.

2. The system of claim 1, wherein the determination of the proximity of the personnel identifier system is individually performed on each of the detection subsystems based on the identification of the personnel identifier system.

3. The system of claim 1, wherein, for each of the one or more detection subsystems, the controller is configured to:
determine that the proximity of the personnel identifier system relative to the respective detection subsystem is within a first threshold proximity; and
wherein the diagnosing the operating status of the respective detection subsystem is approved for operation based on the determination that the personnel identifier system is within the first threshold proximity of the respective detection subsystem.

4. The system of claim 3, wherein, for each of the one or more detection subsystems, the controller is configured to:
determine that the proximity of the personnel identifier system relative to the respective detection subsystem is within a second threshold proximity, the second threshold proximity being less than the first threshold proximity; and
wherein the diagnosing of the respective detection subsystem is approved for operation further based on the determination that the personnel identifier system is within the second threshold proximity of the respective detection subsystem.

5. The system of claim 1, wherein each of the one or more detection subsystems further comprises a lighting subsystem that includes a light output, wherein the controller is configured, when the diagnosing of the operating status of the respective detection subsystem is approved for operation, to activate the light output of the lighting subsystem.

6. The system of claim 1, wherein each of the one or more detection subsystems further comprises a lighting subsystem that includes a variable light output, the variable light output of the respective lighting subsystem being activatable corresponding to diagnosing of different operating statuses of the respective detection subsystem.

7. The system of claim 6, wherein, for each of the one or more detection subsystems, the controller is configured, when the personnel identifier system is within a first threshold proximity of the respective detection subsystem, to variably activate the corresponding light output of the respective lighting subsystem to a first light output; and
when the personnel identifier system is outside the first threshold proximity of the respective detection subsystem, to variably activate the corresponding light output of the respective lighting subsystem to a second light output that is different from the first light output.

8. (canceled)

9. (canceled)

10. The system of claim 1, wherein, for each of the one or more detection subsystems, the controller is configured such that:
when the personnel identifier system is determined to be outside a first threshold proximity of the respective detection subsystem based on the identification of the personnel identifier system, the diagnosing of the operating status indicates a non-approved operating status.

11. The system of claim 1, wherein the controller is configured such that the diagnosing of the operating status of each of the one or more detection subsystems is approved for operation based on a detection sequence amongst the detection subsystems.

12. (canceled)

13. (canceled)

14. (canceled)

15. The system of claim 1, wherein, for each of the one or more detection subsystems, the controller is configured to:
determine an amount of time that the personnel identifier system is at a predetermined distance from the respective detection subsystem; and
wherein the diagnosing the operating status of the respective detection subsystem is approved for operation based on the amount of time exceeding an inspection time threshold.

16. The system of claim 15, wherein the controller is configured to determine an amount of time that the personnel identifier system is within the predetermined distance from the respective detection subsystem.

17. (canceled)

18. The system of claim 1, wherein the controller is configured to:
determine, based on the proximity of the personnel identifier system to the one or more detection systems, a displacement path of the personnel identifier system relative to the vehicle system; and
perform the diagnosing based on the displacement path.

19. (canceled)

20. (canceled)

21. (canceled)

22. The system of claim 1, wherein the controller is configured to:
determine that the operating status of the collision avoidance system is approved for operation; and
enable engine start-up in response to determination that the operating status of the collision avoidance system is approved for operation.

23. The system of claim 1, wherein, for at least one or more detection subsystems, the controller is configured to determine that no communication can be established between the personnel identifier system and the respective detection subsystem, and in response the diagnosing of the operating status indicates a non-approved operating status of the respective detection subsystem.

24. (canceled)

25. (canceled)

26. (canceled)

27. (canceled)

28. The system of claim 1, wherein the controller is configured to:
determine an identification of an authorized operator of the vehicle system; and
enable, when identification of the personnel identifier system matches the authorized operator and when the diagnosing the operating status of the respective detection subsystem is approved for operation, start-up of the vehicle system.

29. (canceled)

30. (canceled)

31. The system of claim 1, wherein the determining of the proximity of the personnel identifier system is performed through each respective wireless communication subsystem using time-of-flight to the personnel identifier system.

32. (canceled)

33. (canceled)

34. (canceled)

35. The system of claim 1, wherein the one or more detection subsystems is configured to perform the determining of the proximity of the personnel identifier system and the receiving of the identification of the personnel identifier system from the personnel identifier system using a wireless communication protocol.

36. The system of claim 1, further comprising the personnel identifier system.

37. (canceled)

38. A mining vehicle, comprising:
a collision avoidance system for avoiding collision with a personnel identifier system that is wearable, the personnel identifier system configured to transmit an identification of the personnel identifier system, the collision avoidance system comprising:
a vehicle system, comprising:
one or more detection subsystems, the one or more detection subsystems including a respective wireless communication subsystem configured to determine a proximity of the personnel identifier system and receive the identification of the personnel identifier system from the personnel identifier system;
a memory; and
a controller for executing instructions stored in the memory that, when executed, causes the controller to:
based on the determination of the proximity of the personnel identifier system relative to the one or more detection subsystems and the identification of the personnel identifier system, diagnose an operating status of each of the one or more detection subsystems.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. A method of avoiding collision between a vehicle system and a personnel identifier system that is wearable, the personnel identifier system configured to transmit an identification of the personnel identifier system, the method being executed by a controller of the vehicle system, the vehicle system having one or more detection subsystems, each of the one or more detection subsystems including a respective wireless communication subsystem, configured to determine a proximity of the personnel identifier system and receive the identification of the personnel identifier system from the personnel identifier system, the method comprising:
based on the determination of the proximity of the personnel identifier system relative to the one or more detection subsystems and the identification of the personnel identifier system, diagnosing an operating status of each of the one or more detection subsystems.

62. (canceled)
